(19) United States
(12) Patent Application Publication
(10) Pub. No.: US 2025/0384820 A1
(43) Pub. Date: Dec. 18, 2025

(54) DISPLAY DEVICE AND ELECTRONIC DEVICE

(71) Applicant: Samsung Display Co., LTD., Yongin-si (KR)

(72) Inventors: Jin Young ROH, Yongin-si (KR); Bon Seog GU, Yongin-si (KR); Hae Kwan SEO, Yongin-si (KR); Jae Keun LIM, Yongin-si (KR)

(21) Appl. No.: 19/191,284

(22) Filed: Apr. 28, 2025

(30) Foreign Application Priority Data
Jun. 18, 2024 (KR) 10-2024-0079222
Nov. 11, 2024 (KR) 10-2024-0159595

(51) Int. Cl. G09G 3/32; G09G 3/3233; G09G 3/3266

(52) U.S. Cl. CPC G09G 3/32; G09G 3/3233; G09G 3/3266; G09G 2300/0819; G09G 2310/0267; G09G 2310/08; G09G 2330/021

(57) ABSTRACT

A display device includes first and second pixels, connected to a same data line. The first pixel includes: a (1-1)th transistor which controls an amount of a first driving current, based on a first data voltage; and a first additional transistor which receives the first data voltage from the data line. The second pixel includes: a (2-1)th transistor which controls an amount of a second driving current, based on a second data voltage; a (2-2)th transistor which receives the second data voltage from the data line and receives a (1-1)th scan signal; and a second additional transistor which receives the second data voltage from the data line and is connected in series to the (2-2)th transistor. Gate electrodes of the first and second additional transistors receive a same control signal, and conductivity types of the first and second additional transistors are different from each other.

This application claims priority to Korean patent application No. 10-2024-0079222, filed on Jun. 18, 2024, and Korean patent application No. 10-2024-0159595, filed on Nov. 11, 2024, and all the benefits accruing therefrom under 35 U.S.C. § 119, the contents of which in their entireties are herein incorporated by reference.

### BACKGROUND

### 1. Field

The disclosure generally relates to a display device and an electronic device.

### 2. Description of the Related Art

With the development of information technologies, the importance of a display device which is a connection medium between a user and information increases. Accordingly, display devices such as a liquid crystal display device and an organic light emitting display device are widely used in various fields. A display device typically includes pixels, and the pixels emit light with a luminance based on data voltages, thereby displaying an image. A data driver may supply data voltages to the pixels, and a demultiplexer may be located between the data driver and the pixels.

### SUMMARY

In a case where a demultiplexer is located between a data driver and pixels, production cost may be reduced by decreasing the size of the data driver. However, in this case, power consumption may be increased due to the demultiplexer and a non-display area may be increased to provide a space for the demultiplexer.

Embodiments provide a display deice and an electronic device, in which functions of a demultiplexer can be implemented in a pixel.

In accordance with an embodiment of the disclosure, a display device includes a first pixel and a second pixel, connected to a same data line, where the first pixel includes: a (1-1)th transistor which controls an amount of a first driving current, based on a first data voltage; and a first additional transistor which receives the first data voltage from the data line, where the second pixel includes: a (2-1)th transistor which controls an amount of a second driving current, based on a second data voltage; a (2-2)th transistor which receives the second data voltage from the data line, where the (2-2)th transistor receives a (1-1)th scan signal; and a second additional transistor which receives the second data voltage from the data line, where the second additional transistor is connected in series to the (2-2)th transistor, and where a gate electrode of the first additional transistor and a gate electrode of the second additional transistor receive a same control signal, and conductivity types of the first additional transistor and the second additional transistor are different from each other.

In an embodiment, a voltage level of the same control signal may be changed during a period in which the (1-1)th scan signal having a turn-on level is received.

In an embodiment, the first pixel may further include a (1-2)th transistor which receives the first data voltage from the data line, where the (1-2)th transistor is connected in series to the first additional transistor.

In an embodiment, a first electrode of the first additional transistor may be connected between the (2-2)th transistor and the second additional transistor.

In an embodiment, the display device may further include a plurality of scan drivers. In such an embodiment, the plurality of scan drivers may include a first scan driver which outputs the (1-1)th scan signal and a control scan driver which outputs the same control signal. In such an embodiment, a number of scan stages included in each of the first scan driver and the control scan driver may be N, and a number of scan stages included in each of the other scan drivers except the first scan driver and the control scan driver among the plurality of scan drivers may be M, where M may be an integer greater than 0, and N may be an integer greater than M.

In an embodiment, the display device may further include a plurality of scan drivers. In such an embodiment, the plurality of scan drivers may include a first scan driver which outputs the (1-1)th scan signal. In such an embodiment, a number of scan stages included in the first scan driver may be N, and a number of scan stages included in each of the other scan drivers except the first scan driver among the plurality of scan drivers may be M, where M may be an integer greater than 0, and N may be an integer greater than M.

In an embodiment, the display device may further include a third pixel and a fourth pixel, connected to the data line. In such an embodiment, the third pixel may include: a (3-1)th transistor which controls an amount of a third driving current, based on a third data voltage; and a third additional transistor which receives the third data voltage from the data line. In such an embodiment, the fourth pixel may include: a (4-1)th transistor which controls an amount of a fourth driving current, based on a fourth data voltage; a (4-2)th transistor which receives the fourth data voltage from the data line, where the (4-2)th transistor receives a (1-2)th scan signal; and a fourth additional transistor which receives the fourth data voltage from the data line, where the fourth additional transistor is connected in series to the (4-2)th transistor. In such an embodiment, a gate electrode of the third additional transistor and a gate electrode of the fourth additional transistor may receive the same control signal, and conductivity types of the third additional transistor and the fourth additional transistor may be different from each other.

In an embodiment, conductivity types of the first additional transistor and the fourth additional transistor may be the same as each other, and conductivity types of the second additional transistor and the third additional transistor may be the same as each other.

In an embodiment, a period in which the (1-1)th scan signal having a turn-on level is received and a period in which the (1-2)th scan signal having a turn-on level is received may be different from each other. The voltage level of the same control signal may be primarily changed during the period in which the (1-1)th scan signal having the turn-on level is received, and the voltage level of the same control signal may be secondarily changed during the period in which the (1-2)th scan signal having the turn-on level is received.

In an embodiment, the third pixel may further include a (3-2)th transistor which receives the third data voltage from the data line, where the (3-2)th transistor is connected in series to the third additional transistor.

In an embodiment, a first electrode of the third additional transistor may be connected between the (4-2)th transistor and the fourth additional transistor.

In an embodiment, the first pixel may further include a (1-1)th emission transistor which allows the first driving current to flow therethrough in case that a (1-1)th emission signal having a turn-on level is received. In such an embodiment, the second pixel may further include a (2-1)th emission transistor which allows the second driving current to flow therethrough in case that the (1-1)th emission signal having the turn-on level is received. In such an embodiment, the same control signal may be a (1-2)th emission signal. In such an embodiment, the (1-1)th emission signal may have a phase delayed from a phase of the (1-2)th emission signal.

In an embodiment, the first pixel may further include a (1-2)th emission transistor which allows the first driving current to flow therethrough in case that a second emission signal having a turn-on level is received. In such an embodiment, the second pixel may further include a (2-2)th emission transistor which allows the second driving current to flow therethrough in case that the second emission signal having the turn-on level is received.

In an embodiment, the display device may further include: a first emission driver which outputs the (1-1)th emission signal and the (1-2)th emission signal; and a second emission driver which outputs the second emission signal. In such an embodiment, a number of emission stages included in the first emission driver may be P, and a number of emission stages included in the second emission driver may be Q, where Q may be an integer greater than 0, and P may be an integer greater than Q.

In an embodiment, a gate electrode of the (2-1)th transistor may be connected to a first node, a first electrode of the (2-1)th transistor may be connected to a second node, and a second electrode of the (2-1)th transistor may be connected to a third node. In such an embodiment, the (2-2)th transistor and the second additional transistor may be connected between the data line and the first node. In such an embodiment, the (2-1)th emission transistor may be connected between the third node and a fourth node, and the (2-2)th emission transistor may be connected between the second node and a first power line.

In an embodiment, the second pixel may further include: a light emitting element including an anode electrode connected to the fourth node; a (2-3)th transistor connected between the first node and a reference voltage line; a (2-4)th transistor connected between the fourth node and an initialization voltage line; a first capacitor connected between the first node and the third node; and a second capacitor connected between the first power line and the third node.

In an embodiment, a gate electrode of the (2-1)th transistor may be connected to a first node, a first electrode of the (2-1)th transistor may be connected to a second node, a second electrode of the (2-1)th transistor may be connected to a third node, and a body of the (2-1)th transistor may be connected to a fourth node. In such an embodiment, the (2-2)th transistor and the second additional transistor may be connected between the data line and the fourth node.

In an embodiment, the second pixel may further include: a light emitting element including an anode electrode connected to the third node; a (2-3)th transistor connected between the fourth node and a reference voltage line; and a (2-4)th transistor connected between the fourth node and an initialization voltage line.

In an embodiment, the second pixel may further include: a (2-5)th transistor connected between a first power line and the second node; a (2-6)th transistor connected between the first power line and the first node; and a (2-7)th transistor connected between the first node and the second node.

In an embodiment, a gate electrode of the (2-7)th transistor may receive a (2-1)th scan signal. In such an embodiment, the same control signal may be a (2-2)th scan signal, and the (2-2)th scan signal may have a phase delayed from a phase of the (2-1)th scan signal.

In accordance with another embodiment of the disclosure, an electronic device includes: a timing controller which receives grayscales for an input image from a processor; a data driver which provides data voltages to data lines, based on the grayscales; a scan driver which provides scan signals to scan lines; a control scan driver which provides control signals to control lines; and a display panel including a plurality of pixels connected to the data lines, the scan lines, and the control lines, where the display panel includes a first pixel and a second pixel, connected to a same data line among the data lines, where the first pixel includes: a (1-1)th transistor which controls an amount of a first driving current, based on a first data voltage; and a first additional transistor which receives the first data voltage from the data line, where the second pixel includes: a (2-1)th transistor which controls an amount of a second driving current, based on a second data voltage; a (2-2)th transistor which receives the second data voltage from the data line, where the (2-2)th transistor receives a (1-1)th scan signal; and a second additional transistor which receives the second data voltage from the data line, where the second additional transistor is connected in series to the (2-2)th transistor, and where a gate electrode of the first additional transistor and a gate electrode of the second additional transistor receive a same control signal, and conductivity types of the first additional transistor and the second additional transistor are different from each other.

### BRIEF DESCRIPTION OF THE DRAWINGS

The above and other features of embodiments of the invention will become more apparent by describing in further detail embodiments thereof with reference to the accompanying drawings.

FIG. 1 is a diagram illustrating a display device in accordance with an embodiment of the disclosure.

FIGS. 2 to 6 are diagrams illustrating a pixel of the display device shown in FIG. 1 and a method of driving the pixel.

FIG. 7 is a diagram illustrating a display device in accordance with another embodiment of the disclosure.

FIGS. 8 to 10 are diagrams illustrating a pixel of the display device shown in FIG. 7 and a method of driving the pixel.

FIG. 11 is a diagram illustrating a display device in accordance with still another embodiment of the disclosure.

FIGS. 12 to 19 are diagrams illustrating a pixel of the display device shown in FIG. 11 and a method of driving the pixel.

FIG. 20 is a diagram illustrating a display device in accordance with still another embodiment of the disclosure.

FIGS. 21 to 23 are diagrams illustrating a pixel of the display device shown in FIG. 20 and a method of driving the pixel.

FIG. 24 is a block diagram of an electronic device in accordance with embodiments of the disclosure.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art.

A part irrelevant to the description will be omitted to clearly describe the disclosure, and the same or similar constituent elements will be designated by the same reference numerals throughout the specification. Therefore, the same reference numerals may be used in different drawings to identify the same or similar elements.

In the drawing figures, dimensions may be exaggerated for clarity of illustration. It will be understood that, in case that an element is referred to as being “between” two elements, it can be the only element between the two elements, or one or more intervening elements may also be present.

It will be understood that when an element is referred to as being “on” another element, it can be directly on the other element or intervening elements may be present therebetween. In contrast, when an element is referred to as being “directly on” another element, there are no intervening elements present.

In addition, the size and thickness of each component illustrated in the drawings are arbitrarily shown for better understanding and ease of description, but the disclosure is not limited thereto. Thicknesses of several portions and regions are exaggerated for clear expressions.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

In description, the expression “equal” may mean “substantially equal.” That is, this may mean equality to a degree to which those skilled in the art can understand the equality. Other expressions may be expressions in which “substantially” is omitted.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

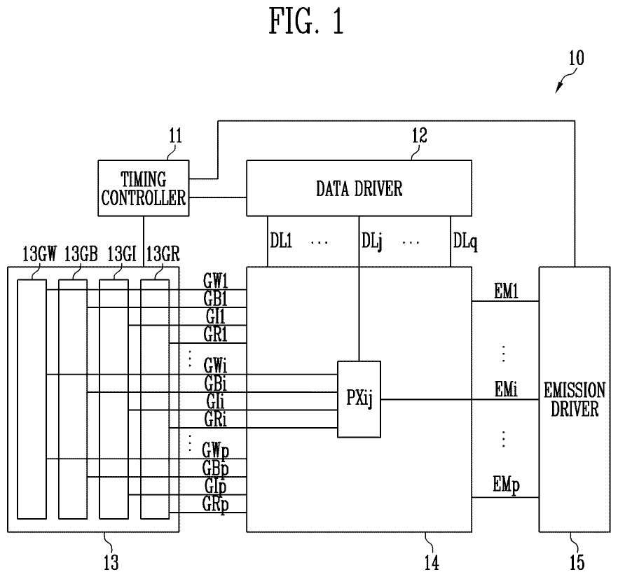

FIG. 1 is a diagram illustrating a display device in accordance with an embodiment of the disclosure.

Referring to FIG. 1, a display device 10 in accordance with an embodiment of the disclosure may include a timing controller 11, a data driver 12, a scan driver 13, a pixel unit 14, and an emission driver 15.

In an embodiment, the timing controller 11 may receive grayscales for an input image (or an input frame) (e.g., an input image data) from an external device (e.g., a processor). The grayscales may include a first color grayscale, a second color grayscale, and a third color grayscale. The first color grayscale may be a grayscale for expressing a first color, the second color grayscale may be a grayscale for expressing a second color, and the third color grayscale may be a grayscale for expressing a third color.

In an embodiment, the timing controller 11 may receive a control signal for an image. The control signal may include a horizontal synchronization signal, a vertical synchronization signal, and a data enable signal. The vertical synchronization signal may include a plurality of pulses, and indicate that a previous frame period is ended and a current frame period is started with respect to a time point at which each of the pulses is generated. An interval between adjacent pulses of the vertical synchronization signal may correspond to a frame period. The horizontal synchronization signal may include a plurality of pulses, and indicate that a previous horizontal period is ended and a new horizontal period is started with respect to a time point at which each of the pulses is generated. An interval between adjacent pulses of the horizontal synchronization signal may correspond to a horizontal period. The data enable signal may have an enable level with respect to specific horizontal periods and have a disable level in remaining periods. In case that the data enable signal is at the enable level, color grayscales may be supplied in corresponding periods.

The timing controller 11 may provide the data driver 12 with grayscales rendered or corrected to be suitable for specifications of the display device 10. Also, the timing controller 11 may provide the scan driver 13 with a clock signal, a scan start signal, or the like. The timing controller 11 may provide the emission driver 15 with a clock signal, an emission stop signal, or the like.

The data driver 12 may generate data voltages to be provided to data lines DL1, . . . , DLj, . . . , and DLq, using grayscales and control signals, which are received from the timing controller 11. In an embodiment, for example, the data driver 12 may sample grayscales, using a clock signal, and apply data voltages corresponding to the grayscales to the data lines DL1 to DLq in units of pixel rows. Here, q may be an integer greater than 1, and j may be an integer greater than 0 and less than q.

In an embodiment, the scan driver 13 may include first to fourth scan drivers 13GW, 13GR, 13GB, and 13GI. The first scan driver 13GW may provide first scan signals to first scan lines GW1, . . . , GWi, . . . , and GWp. Here, p may be an integer greater than 1, and i may be an integer greater than 0 and less than p. The second scan driver 13GR may provide second scan signals to second scan lines GR1, . . . , GRi, . . . , and GRp. The third scan driver 13GB may provide third scan signals to third scan lines GB1, . . . , GBi, . . . , GBp. The fourth scan driver 13GI may provide fourth scan signals to fourth scan lines GI1, . . . , GIi, . . . , and GIp.

In an embodiment, for example, the first scan driver 13GW may generate the first scan signals to be supplied to the first scan lines GW1 to GWp by receiving at least one scan clock signal and a scan start signal from the timing controller 11. The first scan driver 13GW may sequentially provide the first scan signals having a pulse of a turn-on level to the first scan lines GW1 to GWp. In an embodiment, for example, the first scan driver 13GW may be configured in the form of shift registers, and generate the first scan signals in a manner that sequentially transfers the scan start signal in the form of a pulse of a turn-on level to a next scan stage under the control of the scan clock signal. Each of the second scan driver 13GR, the third scan driver 13GB, and the fourth scan driver 13GI may be configured similarly to the first scan driver 13GW, and therefore, any repetitive detailed descriptions thereof will be omitted.

The emission driver 15 may generate emission signals to be provided to emission lines EM1, . . . , EMi, . . . , and EMp by receiving at least one emission clock signal and an emission stop signal from the timing controller 11. The emission driver 15 may sequentially provide the emission signals having a pulse of a turn-off level to the emission lines EM1 to EMp. In an embodiment, for example, the emission driver 15 may be configured in the form of shift registers, and generate the emission signals in a manner that sequentially transfer the emission stop signal in the form of a pulse of a turn-off level to a next emission stage under the control of the emission clock signal.

The pixel unit 14 (or display panel) may include pixels. Each pixel PXij may be connected to a corresponding data line DLj, corresponding scan lines GWi, GRi, GBi, and GIi, and a corresponding emission line EMi. Each pixel PXij may include a light emitting element that emits light, based on a received data voltage.

The pixel unit 14 may include first pixels that emits light of the first color, second pixels that emits light of the second color, and third pixels that emits light of the third color. The first color, the second color, and the third color may be different colors. In an embodiment, for example, the first color may be one color among red, green, and blue, the second color may be another color different from the first color among red, green, and blue, and the third color may be the other color different from the first color and the second color among red, green, and blue. In another embodiment, magenta, cyan, and yellow instead of red, green, and blue may be used as the first to third colors.

The pixels of the pixel unit 14 may be arranged in various forms such as diamond PENTILE™, RGB-stripe, S-stripe, real RGB, or normal PENTILE™.

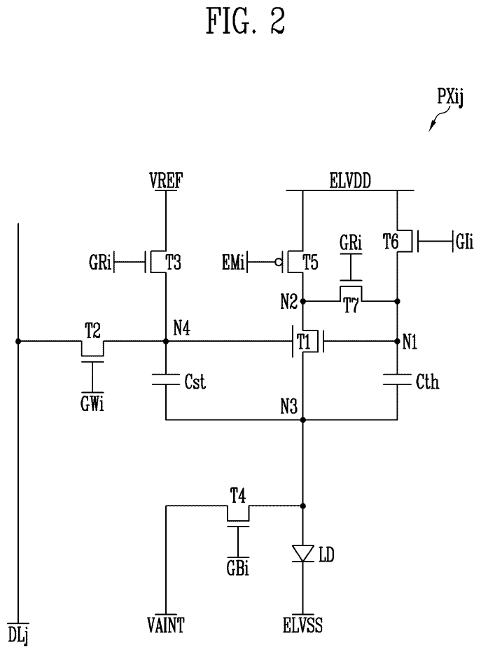

FIGS. 2 to 6 are diagrams illustrating the pixel of the display device shown in FIG. 1 and a method of driving the pixel.

Referring to FIG. 2, a pixel PXij in accordance with an embodiment of the disclosure may include a plurality of transistors T1, T2, T3, T4, T5, T6, and T7, a plurality of capacitors Cst and Cth, and a light emitting element LD.

P-type transistors may be poly-silicon semiconductor transistors. In the poly-silicon semiconductor transistor, a channel of an active layer may include a poly-silicon semiconductor. In an embodiment, for example, the poly-silicon semiconductor transistor may be a low temperature poly-silicon (LTPS) thin film transistor. The poly-silicon semiconductor transistor has a high electron mobility, and has a fast driving characteristic according to the high electron mobility.

N-type transistors may be oxide semiconductor transistors. In the oxide semiconductor transistor, a channel of an active layer may include an oxide semiconductor. In an embodiment, for example, the oxide semiconductor transistor may be a low temperature polycrystalline oxide (LTPO) thin film transistor. The oxide semiconductor transistor has a low charge mobility as compared with the poly-silicon semiconductor transistor. Therefore, an amount of leakage current generated in a turn-off state of the oxide semiconductor transistors may be small as compared with the poly-silicon semiconductor transistors.

A gate electrode of a first transistor T1 may be connected to a first node N1, a first electrode of the first transistor T1 may be connected to a second node N2, a second electrode of the first transistor T1 may be connected to a third node N3, and a body of the first transistor T1 may be connected to a fourth node N4. The first transistor T1 may control an amount of driving current, based on a data voltage. The first transistor T1 may be referred to as a driving transistor. The first transistor T1 may be an N-type transistor.

A gate electrode of a second transistor T2 may be connected to a first scan line GWi, a first electrode of the second transistor T2 may be connected to a data line DLj, and a second electrode of the second transistor T2 may be connected to the fourth node N4. The second transistor T2 may be connected between the data line DLj and the fourth node N4. The second transistor T2 may receive a data voltage from the data line DLj, and receive a first scan signal from the first scan line GWi. The second transistor T2 may be an N-type transistor.

A gate electrode of a third transistor T3 may be connected to a second scan line GRi, a first electrode of the third transistor T3 may be connected to a reference voltage line that receives a reference voltage VREF, and a second electrode of the third transistor T3 may be connected to the fourth node N4. The third transistor T3 may be connected between the fourth node N4 and the reference voltage line. The third transistor T3 may be an N-type transistor.

A gate electrode of a fourth transistor T4 may be connected to a third scan line GBi, a first electrode of the fourth transistor T4 may be connected to an initialization voltage line that receives an initialization voltage VAINT, and a second electrode of the fourth transistor T4 may be connected to the third node N3. The fourth transistor T4 may be connected between the third node N3 and the initialization voltage line. The fourth transistor T4 may be an N-type transistor.

A gate electrode of a fifth transistor T5 may be connected to an emission line EMi, a first electrode of the fifth transistor T5 may be connected to a first power line that receives a first power voltage ELVDD, and a second electrode of the fifth transistor T5 may be connected to the second node N2. The fifth transistor T5 may be connected between the first power line and the second node N2. The fifth transistor T5 may be a P-type transistor.

A gate electrode of a sixth transistor T6 may be connected to a fourth scan line GIi, a first electrode of the sixth transistor T6 may be connected to the first power line that receives the first power voltage ELVDD, and a second electrode of the sixth transistor T6 may be connected to the first node N1. The sixth transistor T6 may be connected between the first power line and the first node N1. The sixth transistor T6 may be an N-type transistor.

A gate electrode of a seventh transistor T7 may be connected to a second scan line GRi, a first electrode of the seventh transistor T7 may be connected to the second node N2, and a second electrode of the seventh transistor T7 may be connected to the first node N1. The seventh transistor T7 may be connected between the first node N1 and the second node N2. The seventh transistor T7 may be an N-type transistor.

A first electrode of a first capacitor Cst may be connected to the fourth node N4, and a second electrode of the first capacitor Cst may be connected to the third node N3. A first electrode of a second capacitor Cth may be connected to the first node N1, and a second electrode of the second capacitor Cth may be connected to the third node N3.

An anode electrode of the light emitting element LD may be connected to the third node N3, and a cathode electrode of the light emitting element LD may be connected to a second power line that receives a second power voltage ELVSS. The light emitting element LD may emit light of one of the first color, the second color, and the third color. The light emitting element LD may be a light emitting diode. The light emitting element LD may be configured as an organic light emitting diode, an inorganic light emitting diode, a quantum dot/well light emitting diode, or the like. In an embodiment, a single light emitting element LD is provided in each pixel. However, in another embodiment, a plurality of light emitting elements may be provided in each pixel. The plurality of light emitting elements may be connected in series, parallel, series/parallel, or the like.

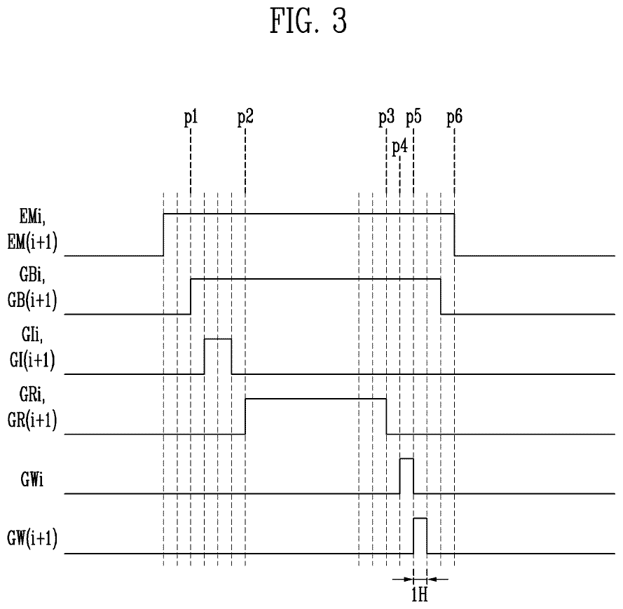

Referring to FIG. 3, an example signal timing diagram for driving the pixel PXij shown in FIG. 2 is illustrated. In accordance with an embodiment, an i-th emission line EMi and an (i+1)-th emission line EM(i+1) may receive a same emission signal. An i-th third scan line GBi and an (i+1)-th third scan line GB(i+1) may receive a same third scan signal. An i-th fourth scan line GIi and an (i+1)-th fourth scan line GI(i+1) may receive a same fourth scan signal. An i-th second scan line GRi and an (i+1)-th second scan line GR(i+1) may receive a same second scan signal.

However, an i-th first scan line GWi and an (i+1)-th first scan line GW(i+1) may receive different first scan signals. In an embodiment, for example, a first scan signal which the (i+1)-th first scan line GW(i+1) receives may have a phase delayed from a phase of a first scan signal which the i-th first scan line GWi receives. In an embodiment, for example, the first scan signal which the (i+1)-th first scan line GW(i+1) receives may be delayed by a horizontal period 1H from the first scan signal which the i-th first scan line GWi receives. In an embodiment, for example, a time width of each first scan signal may correspond to a horizontal period.

In accordance with an embodiment, other control signals except a first scan signal for determining a timing at which data is written are shared by an i-th pixel row and an (i+1)-th pixel row, such that the number of stages included in the scan driver 13 and the emission driver 15 can be decreased. In an embodiment, for example, a number of scan stages included in the first scan driver 13GW may be N, and a number of scan stages included in each of the second, third, and fourth scan drivers 13GR, 13GB, and 13GI may be M. Here, M may be an integer greater than 0, and N may be an integer greater than M. In an embodiment, for example, N may be double of M. In addition, a number of emission stages included in the emission driver 15 may be M.

A period from a time point p1 to a time point p2 may be an initialization period. The fourth transistor T4 may be turned on by a third scan signal having a turn-on level (high level), and the sixth transistor T6 may be turned on by a fourth scan signal having a turn-on level (high level) during the initialization period. Accordingly, the first power voltage ELVDD may be applied to the first electrode of the second capacitor Cth and the initialization voltage VAINT may be applied to the second electrode of the second capacitor Cth, such that voltages at both ends of the second capacitor Cth are initialized.

A period from a time point p2 to a time point p3 may be a compensation period. The fourth transistor T4 may be turned on by a third scan signal having a turn-on level (high level), and the third transistor T3 and the seventh transistor T7 may be turned on by a second scan signal having a turn-on level (high level) during the compensation period. Accordingly, the reference voltage VREF may be applied to the first electrode of the first capacitor Cst, and the initialization voltage VAINT may be applied to the second electrode of the first capacitor Cst, such that voltages at both ends of the first capacitor Cst are initialized. In addition, the first transistor T1 is diode-connected by the turned-on seventh transistor T7 during the compensation period, and therefore, a voltage of the first node N1 may be decreased while flowing out through the seventh transistor T7 and the first transistor T1. In case that a difference in voltage between the first node N1 and the third node N3 corresponds to a threshold voltage of the first transistor T1, the first transistor T1 may be turned off. Therefore, a voltage corresponding to the threshold voltage of the first transistor T1 may be stored in the second capacitor Cth.

A period from a time point p4 to a time point p5 may be a data writing period. The fourth transistor T4 may be turned on by a third scan signal having a turn-on level (high level), and the second transistor T2 may be turned on by a first scan signal having a turn-on level (high level) in the data writing period. Therefore, a data voltage of the data line DLj may be stored in the fourth node N4.

A period after a time point p6 may be an emission period. At the time point p6, the fifth transistor T5 may be turned on by an emission signal having a turn-on level (low level). Therefore, a driving current path may be formed, through which a driving current flows from the first power voltage ELVDD to the second power voltage ELVSS via the fifth transistor T5, the first transistor T1, and the light emitting element LD. An amount of the driving current flowing through the driving current path may be controlled by the first transistor T1, based on the threshold voltage and the data voltage, which have already been stored. A luminance of the light emitting element LD may be determined by the amount of the driving current.

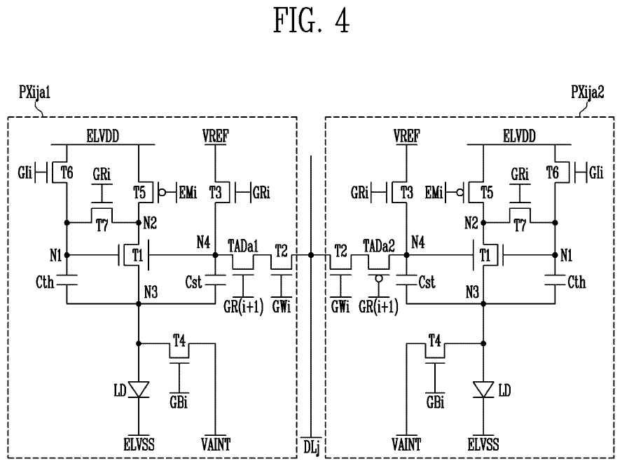

Referring to FIG. 4, a first pixel PXija1 and a second pixel PXija2, which are connected to a same data line DLj, are illustrated. Elements identical to the elements of the pixel PXij shown in FIG. 2 among elements included in the first pixel PXija1 and the second pixel PXija2 are designated by like reference numerals.

A (1-1)th transistor T1 of the first pixel PXija1 may control an amount of a first driving current, based on a first data voltage. A (1-2)th transistor T2 of the first pixel PXija1 may receive the first data voltage from the data line DLj, and receive a (1-1)th scan signal through the first scan line GWi.

The first pixel PXija1 may further include a first additional transistor TADa1 with respect to the pixel PXij shown in FIG. 2. The first additional transistor TADa1 may receive the first data voltage from the data line DLj, and be connected in series to the (1-2)th transistor T2. In an embodiment, for example, the (1-2)th transistor T2 and the first additional transistor TADa1 may be connected between the data line DLj and a fourth node N4.

A (2-1)th transistor T1 of the second pixel PXija2 may control an amount of a second driving current, based on a second data voltage. A (2-2)th transistor T2 of the second pixel PXija2 may receive the second data voltage from the data line DLj, and receive the (1-1)th scan signal through the first scan line GWi.

The second pixel PXija2 may further include a second additional transistor TADa2 with respect to the pixel PXij shown in FIG. 2. The second additional transistor TADa2 may receive the second data voltage from the data line DLj, and be connected in series to the (2-2)th transistor T2. In an embodiment, for example, the (2-2)th transistor T2 and the second additional transistor TADa2 may be connected between the data line DLj and a fourth node N4.

A gate electrode of the first additional transistor TADa1 and a gate electrode of the second additional transistor TADa2 may receive a same control signal. In an embodiment, for example, the gate electrode of the first additional transistor TADal and the gate electrode of the second additional transistor TADa2 may be connected to the (i+1)-th second scan line GR(i+1).

Conductivity types of the first additional transistor TADa1 and the second additional transistor TADa2 may be different from each other. In an embodiment, for example, the first additional transistor TADa1 may be an N-type transistor, and the second additional transistor TADa2 may be a P-type transistor.

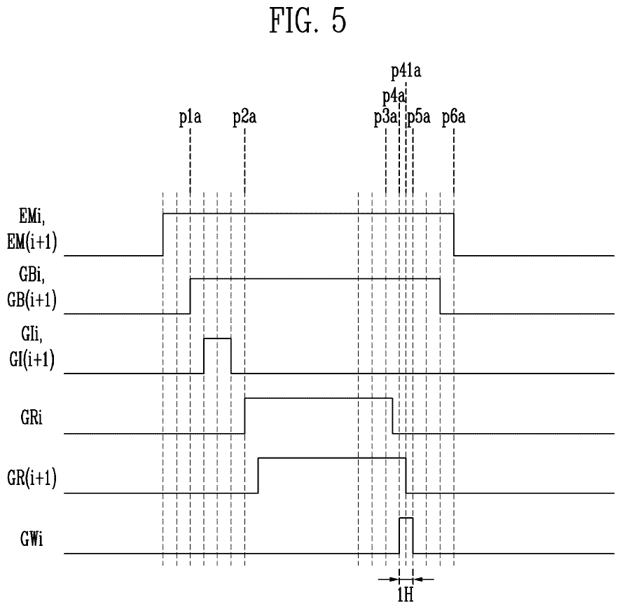

Referring to FIG. 5, an example timing diagram for driving the first pixel PXija1 and the second pixel PXija2, which are shown in FIG. 4, is illustrated. Time points p1a, p2a, p3a, p4a, p5a, and p6a shown in FIG. 5 correspond to the time points p1, p2, p3, p4, p5, p6 shown in FIG. 3, respectively, and therefore, any repetitive detailed descriptions thereof will be omitted. Signals shown in FIG. 5 are substantially the same as the signals shown in FIG. 3, except that the i-th second scan line GRi and the (i+1)-th second scan line GR(i+1) receive different second scan signals.

A gate electrode of a (1-7)th transistor T7 of the first pixel PXija1 and a gate electrode of a (2-7)th transistor T7 of the second pixel PXija2 may receive a (2-1)th scan signal through the i-th second scan lien GRi. The gate electrode of the first additional transistor TADal and the gate electrode of the second additional transistor TADa2 may receive a (2-2)th scan signal through the (i+1)-th second scan line GR(i+1). A control signal may be the (2-2)th scan signal. In an embodiment, for example, the (2-2)th scan signal which the (i+1)-th second scan line GR(i+1) receives may have a phase delayed from a phase of the (2-1)th scan signal which the i-th second scan line GRi receives. In an embodiment, for example, the (2-2)th scan signal may be delayed by a horizontal period 1H from the (2-1)th scan signal.

The second scan driver 13GR which provides the control signal may be defined as a control scan driver. The second scan lines connected to the second scan driver 13GR may be defined as control lines. A number of scan stages included in each of the first scan driver 13GW and the control scan driver 13GR may be N. A number of scan stages included in each of the other scan drivers 13GB and 13GI except the first scan driver 13GW and the control scan driver 13GR among the plurality of scan drivers may be M. Here, M may be an integer greater than 0, and N may be an integer greater than M. In an embodiment, for example, N may be double of (two times) M.

A voltage level of the control signal may be changed during a period from a time point p4a to a time point p5a in which a (1-1)th scan signal having a turn-on level is received. In an embodiment, for example, a voltage level of the (2-2)th scan signal of the second scan line GR(i+1) may be changed at a time point p41a. During a period from the time point p4a to the time point p41a, the first pixel PXija1 may receive the first data voltage through the (1-2)th transistor T2 and the first additional transistor TADa1, which are turned on. During a period from the time point p41a to a time point p5a, the second pixel PXija2 may receive the second data voltage through the (2-2)th transistor T2 and the second additional transistor TADa2, which are turned on.

Thus, in accordance with an embodiment, although no demultiplexer exists between the data driver 12 and the pixel unit 14, the first pixel PXija1 and the second pixel PXija2, which are connected to the same data line DLj, can time-divisionally receive the first data voltage and the second data voltage, respectively.

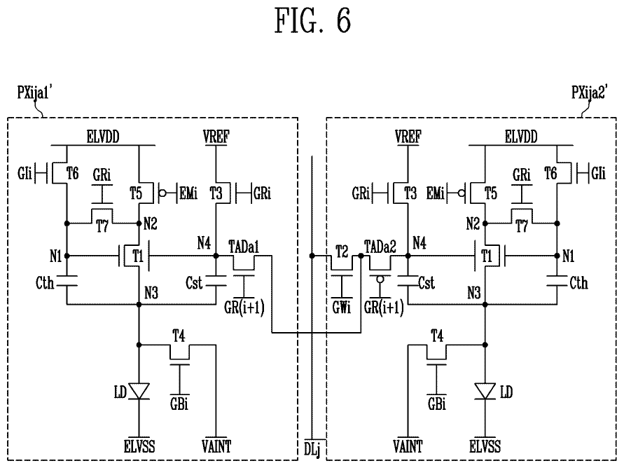

Referring to FIG. 6, a first pixel PXija1′ is substantially the same as the first pixel PXija1 shown in FIG. 4, except that the first pixel PXija1′ does not include the (1-2)th transistor T2. In an embodiment, as shown in FIG. 6, a first electrode of a first additional transistor TADa1 may be connected between a (2-2)th transistor T2 and a second additional transistor TADa2 of a second pixel PXija2′. The first pixel PXija1′ and the second pixel PXija2′, which are shown in FIG. 6, may be driven with the signals of the signal timing diagram shown in FIG. 5.

In accordance with an embodiment, the first pixel PXija1′ does not include the (1-2)th transistor T2, such that a space can be secured as compared with FIG. 4, that is, a space or area occupied by a pixel may be reduced.

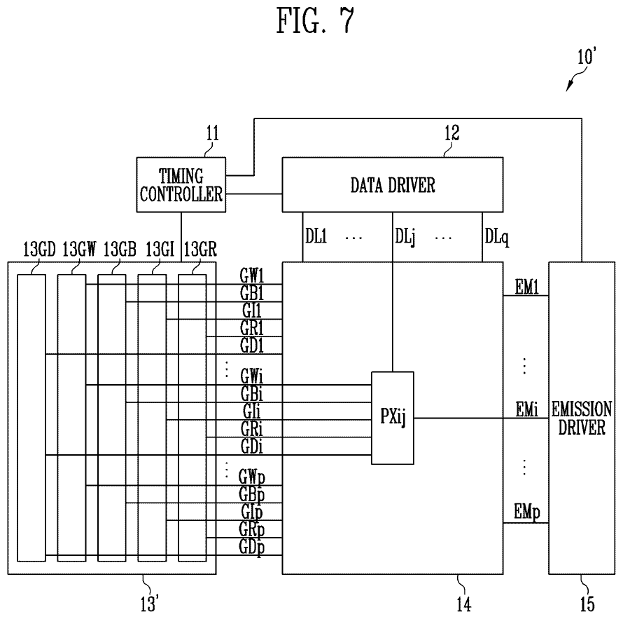

FIG. 7 is a diagram illustrating a display device in accordance with another embodiment of the disclosure.

A display device 10′ shown in FIG. 7 is substantially the same as the display device 10 shown in FIG. 1, except that the display device 10′ further includes a fifth scan driver 13GD. The fifth scan driver 13GD may provide fifth scan signals to fifth scan lines GD1, . . . , GDi, . . . , and GDp. Here, p may be an integer greater than 1, and i may be an integer greater than 0 and less than p.

In an embodiment, for example, the fifth scan driver 13GD may generate fifth scan signals to be provided to the fifth scan lines GD1 to GDp by receiving at least one scan clock signal and a scan start signal from the timing controller 11. The fifth scan driver 13GD may sequentially provide the fifth scan signals having a pulse of a turn-on level to the fifth scan lines GD1 to GDp. In an embodiment, for example, the fifth scan driver 13GD may be configured in the form of shift registers, and generate the fifth scan signals in a manner that sequentially transfers the scan start signal in the form of a pulse of a turn-on level to a next scan stage under the control of the scan clock signal.

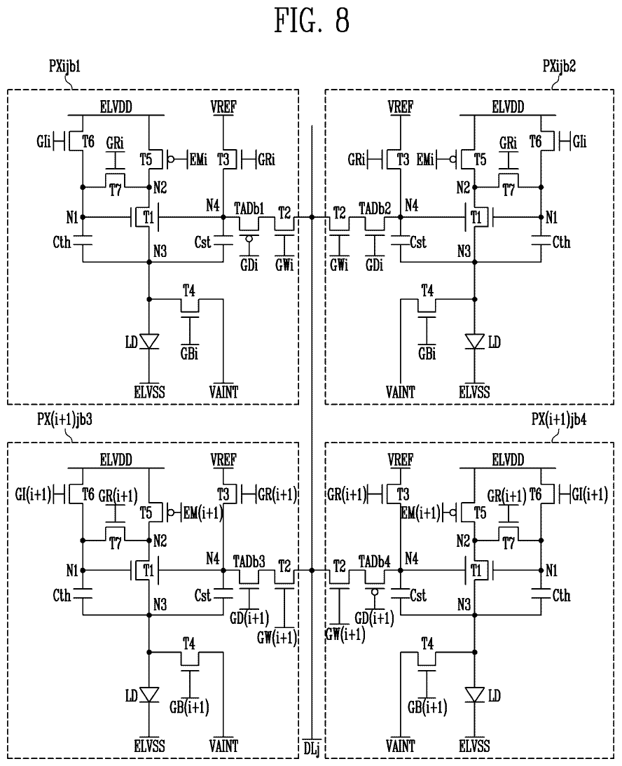

FIGS. 8 to 10 are diagrams illustrating a pixel of the display device shown in FIG. 7 and a method of driving the pixel.

Referring to FIG. 8, a first pixel PXijb1, a second pixel PXijb2, a third pixel PX(i+1)jb3, and a fourth pixel PX(i+1)jb4, which are connected to a same data line DLj, are illustrated. The first pixel PXijb1 and the second pixel PXijb2 may be pixels located on an i-th pixel row, and the third pixel PX(i+1)jb3 and the fourth pixel PX(i+1)jb4 may be pixels located on an (i+1)-the pixel row. Elements identical to the elements of the pixel PXij shown in FIG. 2 among elements included in the first to fourth pixels PXijb1 to PX(i+1)jb4 are designated by like reference numerals.

A (1-1)th transistor T1 of the first pixel PXijb1 may control an amount of a first driving current, based on a first data voltage. A (1-2)th transistor T2 of the first pixel PXijb1 may receive the first data voltage from the data line DLj, and receive a (1-1)th scan signal through the i-th first scan line GWi.

The first pixel PXijb1 may further include a first additional transistor TADb1 with respect to the pixel PXij shown in FIG. 2. The first additional transistor TADb1 may receive the first data voltage from the data line DLj, and be connected in series to the (1-2)th transistor T2. In an embodiment, for example, the (1-2)th transistor T2 and the first additional transistor TADb1 may be connected between the data line DLj and a fourth node N4.

A (2-1)th transistor T1 of the second pixel PXijb2 may control an amount of a second driving current, based on a second data voltage. A (2-2)th transistor T2 of the second pixel PXijb2 may receive the second data voltage from the data line DLj, and receive the (1-1)th scan signal through the i-th first scan line GWi.

The second pixel PXijb2 may further include a second additional transistor TADb2 with respect to the pixel PXij shown in FIG. 2. The second additional transistor TADb2 may receive the second data voltage from the data line DLj, and be connected in series to the (2-2)th transistor T2. In an embodiment, for example, the (2-2)th transistor T2 and the second additional transistor TADb2 may be connected between the data line DLj and a fourth node N4.

A gate electrode of the first additional transistor TADb1 and a gate electrode of the second additional transistor TADb2 may receive a same control signal. In an embodiment, for example, the gate electrode of the first additional transistor TADb1 and the gate electrode of the second additional transistor TADb2 may be connected to an i-th fifth scan line GDi.

Conductivity types of the first additional transistor TADb1 and the second additional transistor TADb2 may be different from each other. In an embodiment, for example, the first additional transistor TADb1 may be a P-type transistor, and the second additional transistor TADb2 may be an N-type transistor.

A (3-1)th transistor T1 of the third pixel PX(i+1)jb3 may control an amount of a third driving current, based on a third data voltage. A (3-2)th transistor T2 of the third pixel PX(i+1)jb3 may receive the third data voltage from the data line DLj, and receive a (1-2)th scan signal through the (i+1)-th first scan line GW(i+1).

The third pixel PX(i+1)jb3 may further include a third additional transistor TADb3 with respect to the pixel PXij shown in FIG. 2. The third additional transistor TADb3 may receive the third data voltage from the data line DLj, and be connected in series to the (3-2)th transistor T2. In an embodiment, for example, the (3-2)th transistor T2 and the third additional transistor TADb3 may be connected between the data line DLj and a fourth node N4.

A (4-1)th transistor T1 of the fourth pixel PX(i+1)jb4 may control an amount of a fourth driving current, based on a fourth data voltage. A (4-2)th transistor T2 of the fourth pixel PX(i+1)jb4 may receive the fourth data voltage from the data line DLj, and receive the (1-2)th scan signal through the (i+1)-th first scan line GW(i+1).

The fourth pixel PX(i+1)jb4 may further include a fourth additional transistor TADb4 with respect to the pixel PXij shown in FIG. 2. The fourth additional transistor TADb4 may receive the fourth data voltage from the data line DLj, and be connected in series to the (4-2)th transistor T2. In an embodiment, for example, the (4-2)th transistor T2 and the fourth additional transistor TADb4 may be connected between the data line DLj and a fourth node N4.

A gate electrode of the third additional transistor TADb3 and a gate electrode of the fourth additional transistor TADb4 may receive a same control signal. In an embodiment, for example, the gate electrode of the third additional transistor TADb3 and the gate electrode of the fourth additional transistor TADb4 may be connected to an (i+1)-th fifth scan line GD(i+1).

Conductivity types of the third additional transistor TADb3 and the fourth additional transistor TADb4 may be different from each other. In an embodiment, for example, the third additional transistor TADb3 may be an N-type transistor, and the fourth transistor TADb4 may be a P-type transistor. In an embodiment, conductivity types of the first additional transistor TADb1 and the fourth additional transistor TADb4 may be the same as each other, and conductivity types of the second additional transistor TADb2 and the third additional transistor TADb3 may be the same as each other.

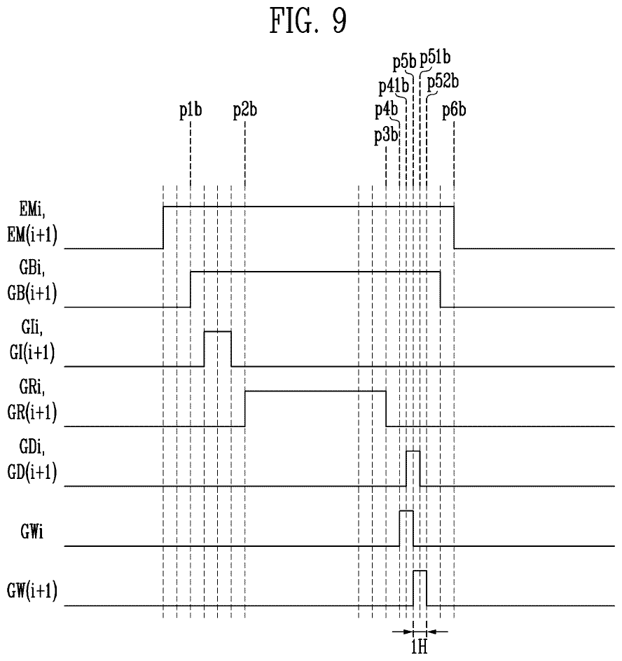

Referring to FIG. 9, an example signal timing diagram for driving the first to fourth pixels PXijb1 to PX(i+1)jb4 shown in FIG. 8 is illustrated. Time points p1b, p2b, p3b, p4b, p5b, and p6b shown in FIG. 9 correspond to the time points p1, p2, p3, p4, p5, p6 shown in FIG. 3, respectively, and therefore, any repetitive detailed descriptions thereof will be omitted. Signals shown in FIG. 9 are substantially the same as the signals shown in FIG. 3, except that a fifth signal is added and that the i-th fifth scan line GDi and the (i+1)-th fifth scan line GD(i+1) receive the same fifth scan signal.

A control signal may be the fifth scan signal. The fifth scan driver 13GD which provides the control signal may be defined as a control scan driver. The fifth scan lines connected to the fifth scan driver 13GD may be defined as control lines. A number of scan stages included in the first scan driver 13GW may N. A number of scan stages included in each of the other scan drivers 13GR, 13GB, 13GI, and 13GD except the first scan driver 13GW among the plurality of scan drivers may be M. Here, M may be an integer greater than 0, and N may be an integer greater than M. In an embodiment, for example, N may be double of M.

A voltage level of the control signal may be primarily changed during a period from a time point p4b to a time point p5b in which a (1-1)th scan signal having a turn-on level is received. In an embodiment, for example, a voltage level of the fifth scan signal may be changed at a time point p41b. During a period from a time point p4b to a time point p41b, the first pixel PXijb1 may receive the first data voltage through the (1-2)th transistor T2 and the first additional transistor TADb1, which are turned on. During a period from the time point p41b to a time point p5b, the second pixel PXijb2 may receive the second data voltage through the (2-2)th transistor T2 and the second additional transistor TADb2, which are turned on.

The period from a time point p4b to the time point p5b in which the (1-1)th scan signal having the turn-on level is received and a period from the time point p5b to a time point p52b in which a (1-2)th scan signal having a turn-on level is received may be different from each other. The (1-2)th scan signal applied to the (i+1)-th first scan line GW(i+1) may have a phase delayed by a horizontal period 1H from a phase of the (1-1)th scan signal applied to the i-th first scan line GWi.

The voltage level of the control signal may be secondarily changed during the period from a time point p5b to the time point p52b in which the (1-2)th scan signal having the turn-on level is received. In an embodiment, for example, the voltage level of the fifth scan signal may be changed at a time point p51b. During a period from the time point p5b to a time point p51b, the third pixel PX(i+1)jb3 may receive the third data voltage through the (3-2)th transistor T2 and the third additional transistor TADb3, which are turned on. During a period from the time point p51b to the time point p52b, the fourth pixel PX(i+1)jb4 may receive the fourth data voltage through the (4-2)th transistor T2 and the fourth additional transistor TADb4, which are turned on.

Thus, in accordance with an embodiment, although no demultiplexer exists between the data driver 12 and the pixel unit 14, the first to fourth pixels PXijb1 to PX(i+1)jb4 connected to the same data line DLj can time-divisionally receive the first to fourth data voltages, respectively.

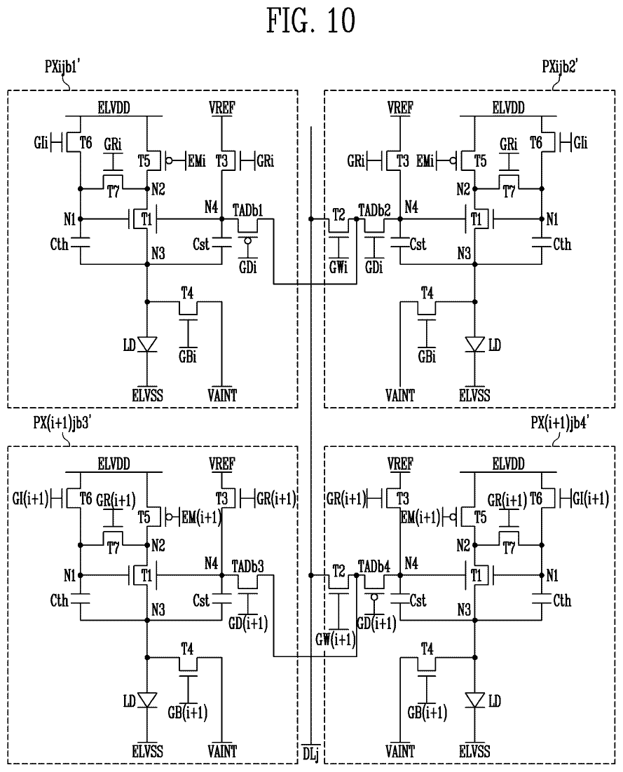

Referring to FIG. 10, a first pixel PXijb1′ is substantially the same as the first pixel PXijb1 shown in FIG. 8, except that the first pixel PXijb1′ does not include the (1-2)th transistor T2. A first electrode of a first additional transistor TADb1 may be connected between a (2-2)th transistor T2 and a second additional transistor TADb2 of a second pixel PXijb2′. In addition, a third pixel PX(i+1)jb3′ is substantially the same as the third pixel PX(i+1)jb3 shown in FIG. 8, except that the third pixel PX(i+1)jb3′ does not include the (3-2)th transistor T2. A first electrode of a third additional transistor TADb3 may be connected between a (4-2)th transistor T2 and a fourth additional transistor TADb4 of a fourth pixel PX(i+1)jb4′. The first to fourth pixels PXijb1′ to PX(i+1)jb4′ shown in FIG. 10, may be driven with the signals of the timing diagram shown in FIG. 9.

In accordance with an embodiment, the first pixel PXijb1′ does not include the (1-2)th transistor T2 and the third pixel PX(i+1)jb3′ does not include the (3-2)th transistor T2, such that a space can be secured as compared with FIG. 8.

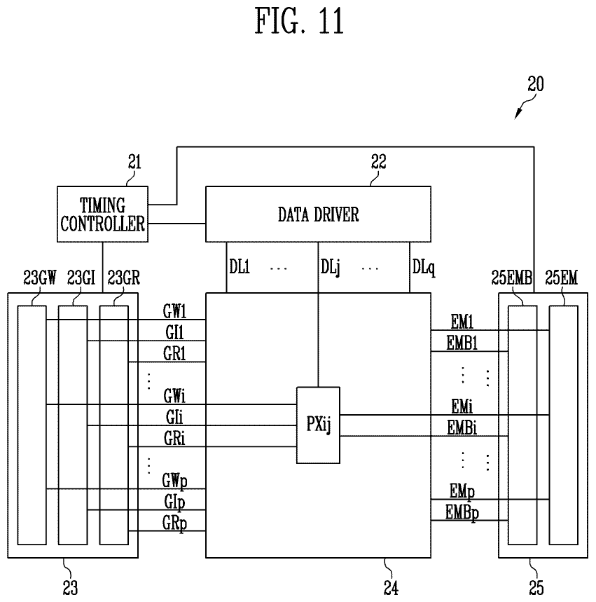

FIG. 11 is a diagram illustrating a display device in accordance with still another embodiment of the disclosure.

Referring to FIG. 11, a display device 20 in accordance with an embodiment of the disclosure may include a timing controller 21, a data driver 22, a scan driver 23, a pixel unit 24, and an emission driver 25.

In an embodiment, the timing controller 21 may receive grayscales for an input image (or an input frame) from an external device (e.g., a processor). The grayscales may include a first color grayscale, a second color grayscale, and a third color grayscale. The first color grayscale may be a grayscale for expressing a first color, the second color grayscale may be a grayscale for expressing a second color, and the third color grayscale may be a grayscale for expressing a third color.

In an embodiment, the timing controller 21 may receive a control signal for an image. The control signal may include a horizontal synchronization signal, a vertical synchronization signal, and a data enable signal. The vertical synchronization signal may include a plurality of pulses, and indicate that a previous frame period is ended and a current frame period is started with respect to a time point at which each of the pulses is generated. An interval between adjacent pulses of the vertical synchronization signal may correspond to a frame period. The horizontal synchronization signal may include a plurality of pulses, and indicate that a previous horizontal period is ended and a new horizontal period is started with respect to a time point at which each of the pulses is generated. An interval between adjacent pulses of the horizontal synchronization signal may correspond to a horizontal period. The data enable signal may have an enable level with respect to specific horizontal periods and have a disable level in remaining periods. In case that the data enable signal is at the enable level, color grayscales may be supplied in corresponding periods.

The timing controller 21 may provide the data driver 22 with grayscales rendered or corrected to be suitable for specifications of the display device 20. Also, the timing controller 21 may provide the scan driver 23 with a clock signal, a scan start signal, or the like. The timing controller 21 may provide the emission driver 25 with a clock signal, an emission stop signal, or the like.

The data driver 22 may generate data voltages to be provided to data lines DL1, . . . , DLj, . . . , and DLq, using grayscales and control signals, which are received from the timing controller 21. In an embodiment, for example, the data driver 22 may sample grayscales, using a clock signal, and apply data voltages corresponding to the grayscales to the data lines DL1 to DLq in units of pixel rows. Here, q may be an integer greater than 1, and j may be an integer greater than 0 and less than q.

The scan driver 23 may include first to third scan drivers 23GW, 13GI, and 13GR. The first scan driver 23GW may provide first scan signals to first scan lines GW1, . . . , GWi, . . . , and GWp. Here, p may be an integer greater than 1, and i may be an integer greater than 0 and less than p. The second scan driver 23GI may provide second scan signals to second scan lines GI1, . . . , GIi, . . . , and GIp. The third scan driver 23GR may provide third scan signals to third scan lines GR1, . . . , GRi, . . . , GRp.

In an embodiment, for example, the first scan driver 23GW may generate the first scan signals to be supplied to the first scan lines GW1 to GWp by receiving at least one scan clock signal and a scan start signal from the timing controller 21. The first scan driver 23GW may sequentially provide the first scan signals having a pulse of a turn-on level to the first scan lines GW1 to GWp. In an embodiment, for example, the first scan driver 23GW may be configured in the form of shift registers, and generate the first scan signals in a manner that sequentially transfers the scan start signal in the form of a pulse of a turn-on level to a next scan stage under the control of the scan clock signal. Each of the second scan driver 23GI and the third scan driver 23GR may be configured similarly to the first scan driver 23GW, and therefore, overlapping descriptions will be omitted.

The emission driver 25 may include a first emission driver 25EMB and a second emission driver 25EM. The first emission driver 25EMB may generate first emission signals to be provided to emission lines EMB1, . . . , EMBi, . . . , and EMBp by receiving at least one emission clock signal and an emission stop signal from the timing controller 21. The first emission driver 25EMB may sequentially provide the first emission signals having a pulse of a turn-off level to the emission lines EMB1 to EMBp. In an embodiment, for example, the first emission driver 25EMB may be configured in the form of shift registers, and generate the first emission signals in a manner that sequentially transfers the emission stop signal in the form of a pulse of a turn-off level to a next emission stage under the control of the emission clock signal. The second emission driver 25EM may sequentially provide second emission signals having a pulse of a turn-off level to emission lines EM1, . . . . EMi, . . . , and Emp. The second emission driver 25EM may be configured similarly to the first emission driver 25EMB, and therefore, overlapping descriptions will be omitted.

The pixel unit 24 may include pixels. Each pixel PXij may be connected to a corresponding data line DLj, corresponding scan lines GWi, GIi, and GRi, and corresponding emission lines EMBi and EMi. Each pixel PXij may include a light emitting element emitting light, based on a received data voltage.

The pixel unit 24 may include first pixels that emits light of the first color, second pixels that emits light of the second color, and third pixels that emits light of the third color. The first color, the second color, and the third color may be different colors. In an embodiment, for example, the first color may be one color among red, green, and blue, the second color may be another color instead of the first color among red, green, and blue, and the third color may be the other color instead of the first color and the second color among red, green, and blue. In addition, magenta, cyan, and yellow instead of red, green, and blue may be used as the first to third colors.

The pixels of the pixel unit 24 may be arranged in various forms such as diamond PENTILE™, RGB-stripe, S-stripe, real RGB, and normal PENTILE™.

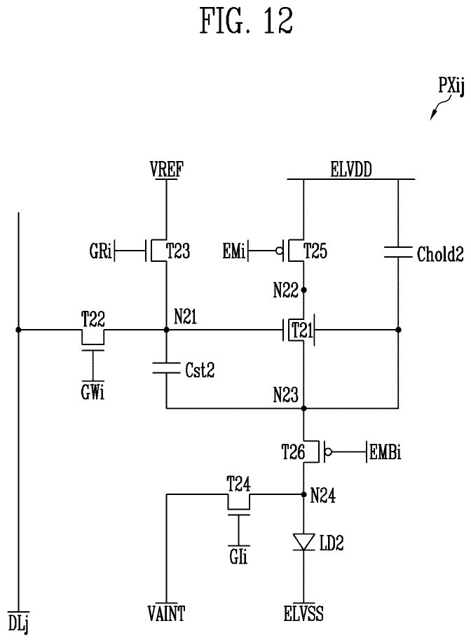

FIGS. 12 to 19 are diagrams illustrating the pixel of the display device shown in FIG. 11 and a method of driving the pixel.

Referring to FIG. 12, a pixel PXij in accordance with an embodiment of the disclosure may include a plurality of transistors T21, T22, T23, T24, T25, and T26, a plurality of capacitors Cst2 and Chold2, and a light emitting element LD2.

P-type transistors may be poly-silicon semiconductor transistors. In the poly-silicon semiconductor transistor, a channel of an active layer may include a poly-silicon semiconductor. In an embodiment, for example, the poly-silicon semiconductor transistor may be a LTPS thin film transistor. The poly-silicon semiconductor transistor has a high electron mobility, and has a fast driving characteristic according to the high electron mobility.

N-type transistors may be oxide semiconductor transistors. In the oxide semiconductor transistor, a channel of an active layer may include an oxide semiconductor. In an embodiment, for example, the oxide semiconductor transistor may be a LTPO thin film transistor. The oxide semiconductor transistor has a low charge mobility as compared with the poly-silicon semiconductor transistor. Therefore, an amount of leakage current generated in a turn-off state of the oxide semiconductor transistors may be small as compared with the poly-silicon semiconductor transistors.

A gate electrode of a first transistor T21 may be connected to a first node N21, a first electrode of the first transistor T21 may be connected to a second node N22, a second electrode of the first transistor T21 may be connected to a third node N23, and a body of the first transistor T21 may be connected to the third node N23. The first transistor T21 may control an amount of driving current, based on a data voltage. The first transistor T21 may be referred to as a driving transistor. The first transistor T21 may be an N-type transistor.

A gate electrode of a second transistor T22 may be connected to a first scan line GWi, a first electrode of the second transistor T22 may be connected to a data line DLj, and a second electrode of the second transistor T22 may be connected to the first node N21. The second transistor T22 may receive a data voltage from the data line DLj, and receive a first scan signal from the first scan line GWi. The second transistor T22 may be an N-type transistor.

A gate electrode of a third transistor T23 may be connected to a third scan line GRi, a first electrode of the third transistor T23 may be connected to a reference voltage line that receives a reference voltage VREF, and a second electrode of the third transistor T23 may be connected to the first node N21. The third transistor T23 may be connected between the first node N21 and the reference voltage line. The third transistor T23 may be an N-type transistor.

A gate electrode of a fourth transistor T24 may be connected to a second scan line GIi, a first electrode of the fourth transistor T24 may be connected to an initialization voltage line that receives an initialization voltage VAINT, and a second electrode of the fourth transistor T24 may be connected to a fourth node N24. The fourth transistor T24 may be connected between the fourth node N24 and the initialization voltage line. The fourth transistor T24 may be an N-type transistor.

A gate electrode of a fifth transistor T25 may be connected to a second emission line EMi, a first electrode of the fifth transistor T25 may be connected to a first power line that receives a first power voltage ELVDD, and a second electrode of the fifth transistor T25 may be connected to the second node N22. The fifth transistor T25 may allow a driving current to flow therethrough in case that the fifth transistor T25 receives a second emission signal having a turn-on level. The fifth transistor T25 may be referred to as a second emission transistor. The fifth transistor T25 may be a P-type transistor.

A gate electrode of a sixth transistor T26 may be connected to a first emission line EMBi, a first electrode of the sixth transistor T26 may be connected to the third node N23, and a second electrode of the sixth transistor T26 may be connected to the fourth node N24. The sixth transistor T26 may be connected between the third node N23 and the fourth node N24. The sixth transistor T26 may allow a driving current to flow therethrough in case that the sixth transistor T26 receives a first emission signal having a turn-on level. The sixth transistor T26 may be referred to as a first emission transistor. The sixth transistor T26 may be a P-type transistor.

A first capacitor Cst2 may be connected between the first node N21 and the third node N23. A second capacitor Chold2 may be connected between the first power line that receives the first power voltage ELVDD and the third node N23.

An anode electrode of the light emitting element LD2 may be connected to the fourth node N24, and a cathode electrode of the light emitting element LD2 may be connected to a second power line that receives a second power voltage ELVSS. The light emitting element LD2 may emit light of one of the first color, the second color, and the third color. The light emitting element LD2 may be a light emitting diode. The light emitting element LD2 may be configured as an organic light emitting diode, an inorganic light emitting diode, a quantum dot/well light emitting diode, or the like. In an embodiment, a single light emitting element LD2 is provided in each pixel. However, in another embodiment, a plurality of light emitting elements may be provided in each pixel. The plurality of light emitting elements may be connected in series, parallel, series/parallel, or the like.

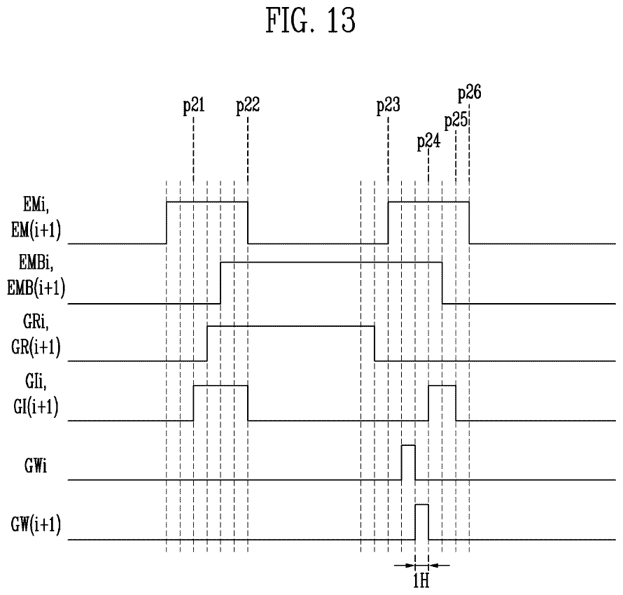

Referring to FIG. 13, an example signal timing diagram for driving the pixel PXij shown in FIG. 12 is illustrated.

In accordance with an embodiment, an i-th first emission line EMBi and an (i+1)-th first emission line EMB(i+1) may receive a same emission signal. An i-th second emission line EMi and an (i+1)-th second emission line EM(i+1) may receive a same emission signal. An i-th third scan line GRi and an (i+1)-th third scan line GR(i+1) may receive a same third scan signal. An i-th second scan line GIi and an (i+1)-th second scan line GI(i+1) may receive a same second scan signal.

However, an i-th first scan line GWi and an (i+1)-th first scan line GW(i+1) may receive different first scan signals. In an embodiment, for example, a first scan signal which the (i+1)-th first scan line GW(i+1) receives may have a phase delayed from a phase of a first scan signal which the i-th first scan line GWi receives. In an embodiment, for example, the first scan signal which the (i+1)-th first scan line GW(i+1) receives may be delayed by a horizontal period 1H from the first scan signal which the i-th first scan line GWi receives. In an embodiment, for example, a time width of each first scan signal may correspond to a horizontal period.

In accordance with an embodiment, other control signals except a first scan signal for determining a timing at which data is written are shared by an i-th pixel row and an (i+1)-th pixel row, such that the number of stages included in the scan driver 23 and the emission driver 25 can be decreased. In an embodiment, for example, a number of scan stages included in the first scan driver 23GW may be N, and a number of scan stages included in each of the second and third scan drivers 23GI and 23GR may be M. Here, M may be an integer greater than 0, and N may be an integer greater than M. In an embodiment, for example, N may be double of M. In addition, a number of emission stages included in each of the first emission driver 25EMB and the second emission driver 25EM may be M.

A period from a time point p21 to a time point p22 may be an initialization period. During the period from the time point p21 to the time point p22, the sixth transistor T26 may be turned on by a first emission signal having a turn-on level (low level), the third transistor T23 may be turned on by a third scan signal having a turn-on level (high level), and the fourth transistor T24 may be turned on by a second scan signal having a turn-on level (high level). Accordingly, the reference voltage VREF may be applied to a first electrode of the first capacitor Cst2, and the initialization voltage VAINT may be applied to a second electrode of the first capacitor Cst2. Therefore, voltages at both ends of the first capacitor Cst2 may be initialized.

A period from a time point p22 to a time point p23 may be a compensation period. During the period from the time point p22 to the time point p23, the fifth transistor T25 may be turned on by a second emission signal having a turn-on level (low level), and the third transistor T23 may be turned on by a third scan signal having a turn-on level (high level). The first transistor T21 may be in a turn-on state by the voltages at both the ends of the first capacitor Cst2, and a voltage of the third node N23 may be gradually increased while a current flows from the first power voltage ELVDD. The first transistor T21 may be turned off in case that a difference in voltage between the first node N21 and the third node N23 corresponds to a threshold voltage of the first transistor T21. Therefore, a voltage corresponding to the threshold voltage of the first transistor T21 may be stored in the first capacitor Cst2.

A period in which a first scan signal having a turn-on level (high level) is supplied to the i-th first scan line GWi may be a data writing period. A data voltage of the data line DLj may be stored at the second node N21.

A period from a time point p24 to a time point p25 may be an anode initialization period. The fourth transistor T24 may be turned on by a second scan signal having a turn-on level (high level) during the anode initialization period. Therefore, the initialization voltage VAINT may be applied to the second node N24 such that a voltage of the anode electrode of the light emitting element LD2 may be initialized. Accordingly, a low grayscale such as a black grayscale may be more effectively expressed.

A period from a time point p25 to a time point p26 may be an emission period. The sixth transistor T26 may be turned on by a first emission signal having a turn-on level (low level), and the fifth transistor T25 may be turned on by a second emission signal having a turn-on level (low level) during the emission period. Therefore, a driving current path may be formed, through which a driving current flows from the first power voltage ELVDD to the second power voltage ELVSS via the fifth transistor T25, the first transistor T21, the sixth transistor T26, and the light emitting element LD2. An amount of the driving current flowing through the driving current path may be controlled by the first transistor T21, based on the threshold voltage and the data voltage, which have already been stored. A luminance of the light emitting element LD2 may be determined by the amount of the driving current.

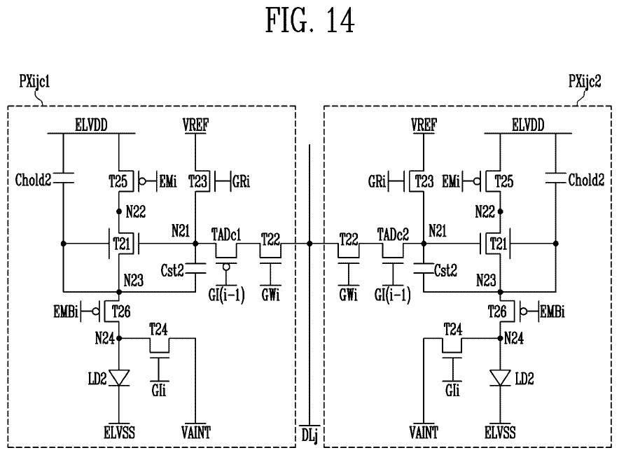

Referring to FIG. 14, a first pixel PXijc1 and a second pixel PXijc2, which are connected to a same data line DLj, are illustrated. Elements identical to the elements of the pixel PXij shown in FIG. 12 among elements included in the first pixel PXijc1 and the second pixel PXijc2 are designated by like reference numerals.

A (1-1)th transistor T21 of the first pixel PXijc1 may control an amount of a first driving current, based on a first data voltage. A (1-2)th transistor T22 of the first pixel PXijc1 may receive the first data voltage from the data line DLj, and receive a (1-1)th scan signal through the first scan line GWi.

The first pixel PXijc1 may further include a first additional transistor TADc1 with respect to the pixel PXij shown in FIG. 12. The first additional transistor TADc1 may receive the first data voltage from the data line DLj, and be connected in series to the (1-2)th transistor T22. In an embodiment, for example, the (1-2)th transistor T22 and the first additional transistor TADc1 may be connected between the data line DLj and a first node N21.

A (2-1)th transistor T21 of the second pixel PXijc2 may control an amount of a second driving current, based on a second data voltage. A (2-2)th transistor T22 of the second pixel PXijc2 may receive the second data voltage from the data line DLj, and receive the (1-1)th scan signal through the first scan line GWi.

The second pixel PXijc2 may further include a second additional transistor TADc2 with respect to the pixel PXij shown in FIG. 12. The second additional transistor TADc2 may receive the second data voltage from the data line DLj, and be connected in series to the (2-2)th transistor T22. In an embodiment, for example, the (2-2)th transistor T22 and the second additional transistor TADc2 may be connected between the data line DLj and a first node N21.

A gate electrode of the first additional transistor TADc1 and a gate electrode of the second additional transistor TADc2 may receive a same control signal. In an embodiment, for example, the gate electrode of the first additional transistor TADc1 and the gate electrode of the second additional transistor TADc2 may be connected to an (i−1)-th second scan line GI(i−1).

Conductivity types of the first additional transistor TADc1 and the second additional transistor TADc2 may be different from each other. In an embodiment, for example, the first additional transistor TADc1 may be a P-type transistor, and the second additional transistor TADc2 may be an N-type transistor.

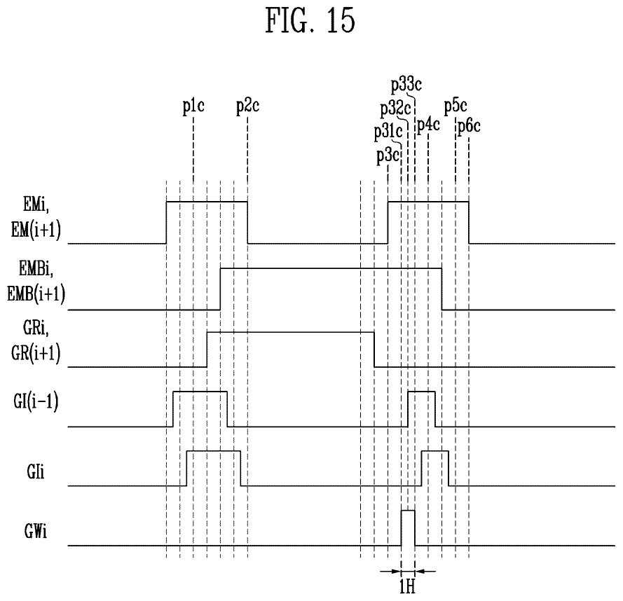

Referring to FIG. 15, an example signal timing diagram for driving the first pixel PXijc1 and the second pixel PXijc2, which are shown in FIG. 14, is illustrated. Time points p1c, p2c, p3c, p4c, p5c, and p6c shown in FIG. 15 correspond to the time points p21, p22, p23, p24, p25, p26 shown in FIG. 13, respectively, and therefore, any repetitive detailed descriptions thereof will be omitted. Signals shown in FIG. 15 are substantially the same as the signals shown in FIG. 13, except that the i-th second scan line GIi and the (i−1)-th second scan line GI(i−1) receive different second scan signals.

A gate electrode of a (1-4)th transistor T24 of the first pixel PXijc1 and a gate electrode of a (2-4)th transistor T24 of the second pixel PXijc2 may receive a (2-1)th scan signal through the i-th second scan lien GIi.

The gate electrode of the first additional transistor TADc1 and the gate electrode of the second additional transistor TADc2 may receive a (2-2)th scan signal through the (i−1)-th second scan line GI(i−1). A control signal may be the (2-2)th scan signal. In an embodiment, for example, the (2-1)th scan signal which the i-th second scan line GIi receives may have a phase delayed from a phase of the (2-2)th scan signal which the (i−1)-th second scan line GI(i−1) receives. In an embodiment, for example, the (2-1)th scan signal may be delayed by a horizontal period 1H from the (2-2)th scan signal.

The second scan driver 23GI which provides the control signal may be defined as a control scan driver. The second scan lines connected to the second scan driver 23GI may be defined as control lines. A number of scan stages included in each of the first scan driver 23GW and the control scan driver 23GI may be N. A number of scan stages included in the other scan driver 23GR except the first scan driver 23GW and the control scan driver 23GI among the plurality of scan drivers may be M. Here, M may be an integer greater than 0, and N may be an integer greater than M. In an embodiment, for example, N may be double of M.

A voltage level of the control signal may be changed during a period from a time point p31c to a time point p33c in which a (1-1)th scan signal having a turn-on level is received. In an embodiment, for example, a voltage level of the (2-2)th scan signal of the (i−1)-th second scan line GI(i−1) may be changed at a time point p32c. During a period from a time point p31c to a time point p32c, the first pixel PXijc1 may receive the first data voltage through the (1-2)th transistor T22 and the first additional transistor TADc1, which are turned on. During a period from a time point p32c to a time point p33c, the second pixel PXijc2 may receive the second data voltage through the (2-2)th transistor T22 and the second additional transistor TADc2, which are turned on.

Thus, in accordance with an embodiment, although no demultiplexer exists between the data driver 22 and the pixel unit 24, the first pixel PXijc1 and the second pixel PXijc2, which are connected to the same data line DLj, can time-divisionally receive the first data voltage and the second data voltage, respectively.

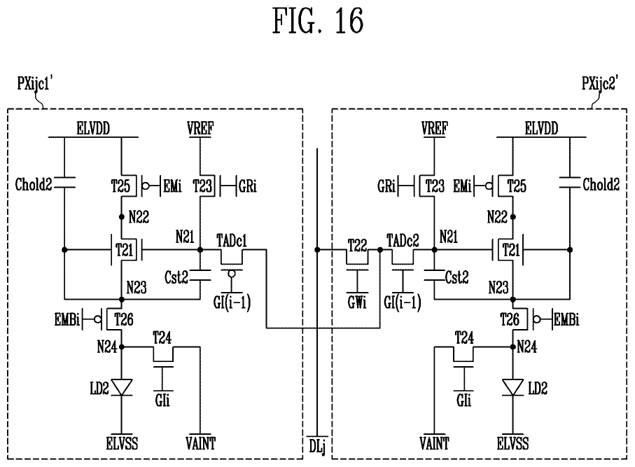

Referring to FIG. 16, a first pixel PXijc1′ shown in FIG. 16 is substantially the same as the first pixel PXijc1 shown in FIG. 14, except that the first pixel PXijc1′ does not include the (1-2)th transistor T22. A first electrode of a first additional transistor TADc1 may be connected between a (2-2)th transistor T22 and a second additional transistor TADc2 of a second pixel PXijc2′. The first pixel PXijc1′ and the second pixel PXijc2′, which are shown in FIG. 16, may be driven with the signals of the signal timing diagram shown in FIG. 15.

In accordance with an embodiment, the first pixel PXijc1′ does not include the (1-2)th transistor T22, such that a space can be secured as compared with FIG. 14.

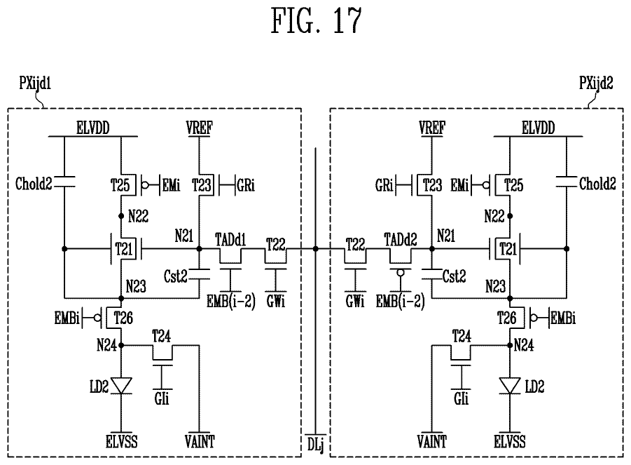

Referring to FIG. 17, a first pixel PXijd1 and a second pixel PXijd2, which are connected to a same data line DLj, are illustrated. Elements identical to the elements of the pixel PXij shown in FIG. 12 among elements included in the first pixel PXijd1 and the second pixel PXijd2 are designated by like reference numerals.

A (1-1)th transistor T21 of the first pixel PXijd1 may control an amount of a first driving current, based on a first data voltage. A (1-2)th transistor T22 of the first pixel PXijd1 may receive the first data voltage from the data line DLj, and receive a (1-1)th scan signal through the first scan line GWi.

The first pixel PXijd1 may further include a first additional transistor TADd1 with respect to the pixel PXij shown in FIG. 12. The first additional transistor TADd1 may receive the first data voltage from the data line DLj, and be connected in series to the (1-2)th transistor T22. In an embodiment, for example, the (1-2)th transistor T22 and the first additional transistor TADd1 may be connected between the data line DLj and a first node N21.

A (2-1)th transistor T21 of the second pixel PXijd2 may control an amount of a second driving current, based on a second data voltage. A (2-2)th transistor T22 of the second pixel PXijd2 may receive the second data voltage from the data line DLj, and receive the (1-1)th scan signal through the first scan line GWi.

The second pixel PXijd2 may further include a second additional transistor TADd2 with respect to the pixel PXij shown in FIG. 12. The second additional transistor TADd2 may receive the second data voltage from the data line DLj, and be connected in series to the (2-2)th transistor T22. In an embodiment, for example, the (2-2)th transistor T22 and the second additional transistor TADd2 may be connected between the data line DLj and a first node N21.

A gate electrode of the first additional transistor TADd1 and a gate electrode of the second additional transistor TADd2 may receive a same control signal. In an embodiment, for example, the gate electrode of the first additional transistor TADd1 and the gate electrode of the second additional transistor TADd2 may be connected to an (i−2)-th first emission line EMB(i−2).

Conductivity types of the first additional transistor TADd1 and the second additional transistor TADd2 may be different from each other. In an embodiment, for example, the first additional transistor TADd1 may be an N-type transistor, and the second additional transistor TADd2 may be a P-type transistor.

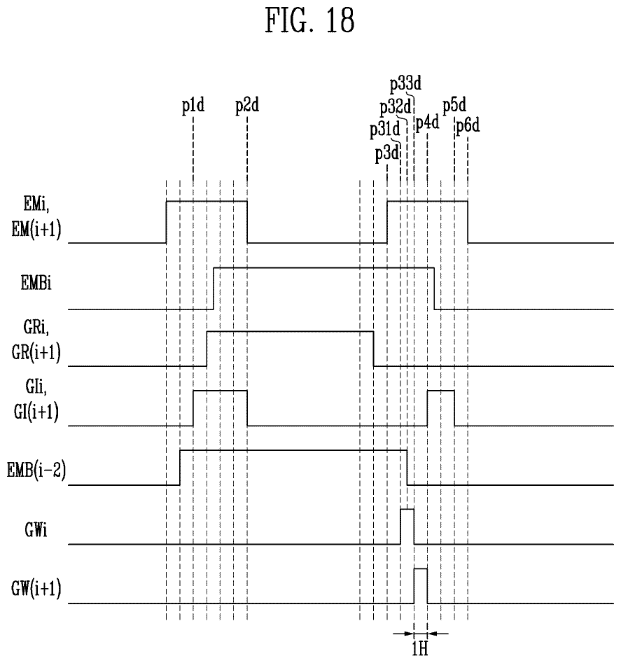

Referring to FIG. 18, an example signal timing diagram for driving the first pixel PXijd1 and the second pixel PXijd2, which are shown in FIG. 17, is illustrated. Time points p1d, p2d, p3d, p4d, p5d, and p6d shown in FIG. 18 correspond to the time points p21, p22, p23, p24, p25, p26 shown in

FIG. 13, respectively, and therefore, any repetitive detailed descriptions thereof will be omitted. Signals shown in FIG. 18 is substantially the same as the signals shown in FIG. 13, except that the i-th first emission line EMBi and the (i−2)-th first emission line EMB(i−2) receive different first emission signals.

A gate electrode of a (1-6)th transistor T26 of the first pixel PXijd1 and a gate electrode of a (2-6)th transistor T26 of the second pixel PXijd2 may receive a (1-1)th emission signal through the i-th first emission line EMBi. The gate electrode of the first additional transistor TADd1 and the gate electrode of the second additional transistor TADd2 may receive a (1-2)th emission signal through the (i−2)-th first emission line EMB(i−2). A control signal may be the (1-2)th emission signal. In an embodiment, for example, the (1-1)th emission signal which the i-th first emission line EMBi receives may have a phase delayed from a phase of the (1-2)th emission signal which the (i−2)-th first emission line EMB(i−2) receives. In an embodiment, for example, the (1-1)th emission signal may be delayed by a horizontal period 1H from the (1-2)th emission signal.

A number of emission stages included in the first emission driver 25EMB may be P, and a number of emission stages included in the second emission driver 25EM may be Q. Here, Q may be an integer greater than 0, and P may be an integer greater than Q. In an embodiment, for example, P may be double of Q.

A voltage level of the control signal may be changed during a period from a time point p31d to a time point p33d in which a (1-1)th scan signal having a turn-on level is received. In an embodiment, for example, a voltage level of the (1-2)th emission signal of the (i−2)-th first emission line EMB(i−2) may be changed at a time point p32d. During a period from a time point p31d to a time point p32d, the first pixel PXijd1 may receive the first data voltage through the (1-2)th transistor T22 and the first additional transistor TADd1, which are turned on. During a period from the time point p32d to a time point p33d, the second pixel PXijd2 may receive the second data voltage through the (2-2)th transistor T22 and the second additional transistor TADd2, which are turned on.

Thus, in accordance with an embodiment, although no demultiplexer exists between the data driver 22 and the pixel unit 24, the first pixel PXijd1 and the second pixel PXijd2, which are connected to the same data line DLj, can time-divisionally receive the first data voltage and the second data voltage, respectively.

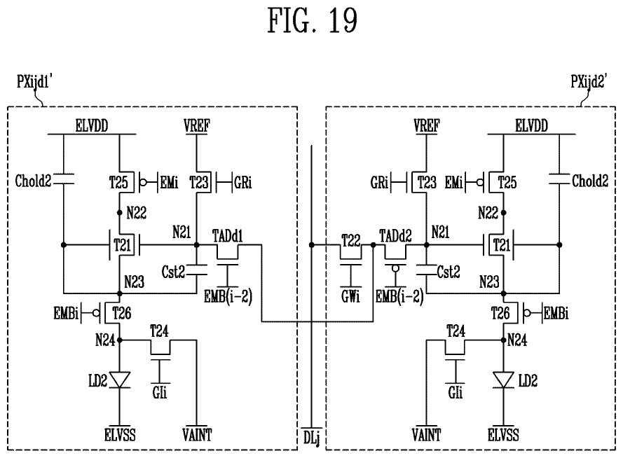

Referring to FIG. 19, a first pixel PXijd1′ is substantially the same as the first pixel PXijd1 shown in FIG. 17, except that the first pixel PXijd1′ does not include the (1-2)th transistor T22. A first electrode of a first additional transistor TADd1 may be connected between a (2-2)th transistor T22 and a second additional transistor TADd2 of a second pixel PXijd2′. The first pixel PXijd1′ and the second pixel PXijd2′, which are shown in FIG. 19, may be driven with the signals shown in the signal timing diagram shown in FIG. 18.

In accordance with an embodiment, the first pixel PXijd1′ does not include the (1-2)th transistor T22, such that a space can be secured as compared with FIG. 17.

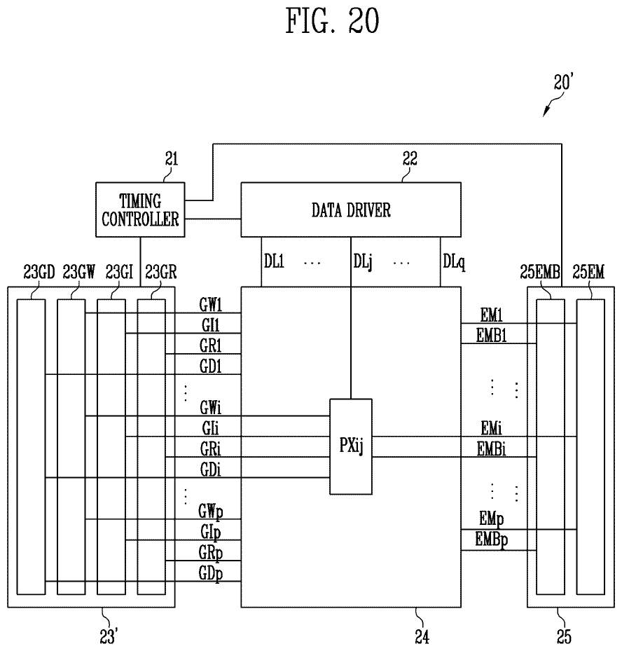

FIG. 20 is a diagram illustrating a display device in accordance with still another embodiment of the disclosure.

A display device 20′ shown in FIG. 20 is substantially the same as the display device 20 shown in FIG. 11, except that the display device 20′ further includes a fourth scan driver 23GD. The fourth scan driver 23GD may provide fourth scan signals to fourth scan lines GD1, . . . , GDi, . . . , and GDp. Here, p may be an integer greater than 1, and i may be an integer greater than 0 and less than p.

In an embodiment, for example, the fourth scan driver 23GD may generate fourth scan signals to be provided to the fourth scan lines GD1 to GDp by receiving at least one scan clock signal and a scan start signal from the timing controller 21. The fourth scan driver 23GD may sequentially provide the fourth scan signals having a pulse of a turn-on level to the fourth scan lines GD1 to GDp. In an embodiment, for example, the fourth scan driver 23GD may be configured in the form of shift registers, and generate the fourth scan signals in a manner that sequentially transfers the scan start signal in the form of a pulse of a turn-on level to a next scan stage under the control of the scan clock signal.

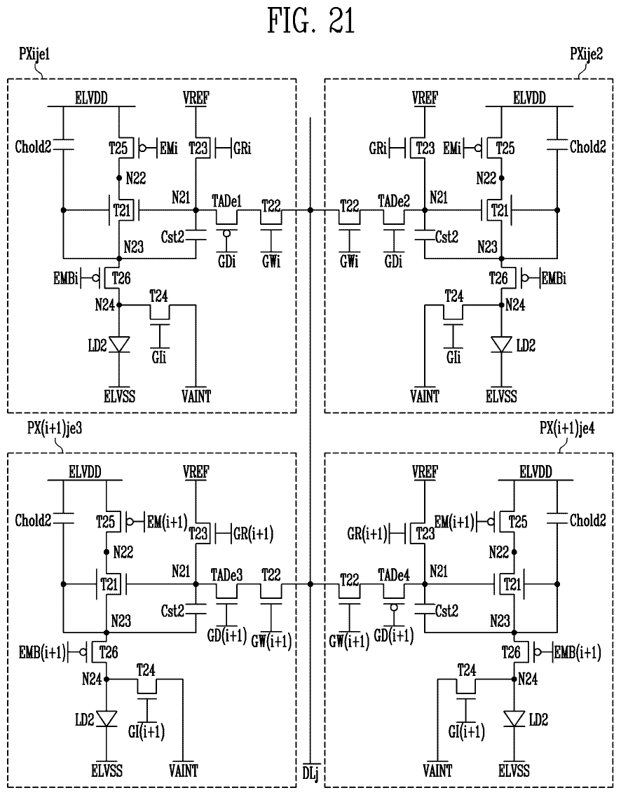

FIGS. 21 to 23 are diagrams illustrating a pixel of the display device shown in FIG. 20 and a method of driving the pixel.

Referring to FIG. 21, a first pixel PXije1, a second pixel PXije2, a third pixel PX(i+1)je3, and a fourth pixel PX(i+1)je4, which are connected to a same data line DLj, are illustrated. The first pixel PXije1 and the second pixel PXije2 may be pixels located on an i-th pixel row, and the third pixel PX(i+1)je3 and the fourth pixel PX(i+1)je4 may be pixels located on an (i+1)-the pixel row. Elements identical to the elements of the pixel PXij shown in FIG. 12 among elements included in the first to fourth pixels PXije1 to PX(i+1)je4 are designated by like reference numerals.

A (1-1)th transistor T21 of the first pixel PXije1 may control an amount of a first driving current, based on a first data voltage. A (1-2)th transistor T22 of the first pixel PXije1 may receive the first data voltage from the data line DLj, and receive a (1-1)th scan signal through the i-th first scan line GWi.

The first pixel PXije1 may further include a first additional transistor TADe1 with respect to the pixel PXij shown in FIG. 12. The first additional transistor TADe1 may receive the first data voltage from the data line DLj, and be connected in series to the (1-2)th transistor T22. In an embodiment, for example, the (1-2)th transistor T22 and the first additional transistor TADe1 may be connected between the data line DLj and a first node N21.

A (2-1)th transistor T21 of the second pixel PXije2 may control an amount of a second driving current, based on a second data voltage. A (2-2)th transistor T22 of the second pixel PXije2 may receive the second data voltage from the data line DLj, and receive the (1-1)th scan signal through the i-th first scan line GWi.

The second pixel PXije2 may further include a second additional transistor TADe2 with respect to the pixel PXij shown in FIG. 12. The second additional transistor TADe2 may receive the second data voltage from the data line DLj, and be connected in series to the (2-2)th transistor T22. In an embodiment, for example, the (2-2)th transistor T22 and the second additional transistor TADe2 may be connected between the data line DLj and a first node N21.

A gate electrode of the first additional transistor TADe1 and a gate electrode of the second additional transistor TADe2 may receive a same control signal. In an embodiment, for example, the gate electrode of the first additional transistor TADe1 and the gate electrode of the second additional transistor TADe2 may be connected to an i-th fourth scan line GDi.

Conductivity types of the first additional transistor TADe1 and the second additional transistor TADe2 may be different from each other. In an embodiment, for example, the first additional transistor TADe1 may be a P-type transistor, and the second additional transistor TADe2 may be an N-type transistor.

A (3-1)th transistor T21 of the third pixel PX(i+1)je3 may control an amount of a third driving current, based on a third data voltage. A (3-2)th transistor T22 of the third pixel PX(i+1)je3 may receive the third data voltage from the data line DLj, and receive a (1-2)th scan signal through the (i+1)-th first scan line GW(i+1).

The third pixel PX(i+1)jb3 may further include a third additional transistor TADe3 with respect to the pixel PXij shown in FIG. 12. The third additional transistor TADe3 may receive the third data voltage from the data line DLj, and be connected in series to the (3-2)th transistor T22. In an embodiment, for example, the (3-2)th transistor T22 and the third additional transistor TADe3 may be connected between the data line DLj and a first node N21.

A (4-1)th transistor T21 of the fourth pixel PX(i+1)je4 may control an amount of a fourth driving current, based on a fourth data voltage. A (4-2)th transistor T22 of the fourth pixel PX(i+1)je4 may receive the fourth data voltage from the data line DLj, and receive the (1-2)th scan signal through the (i+1)-th first scan line GW(i+1).

The fourth pixel PX(i+1)jb4 may further include a fourth additional transistor TADe4 with respect to the pixel PXij shown in FIG. 12. The fourth additional transistor TADe4 may receive the fourth data voltage from the data line DLj, and be connected in series to the (4-2)th transistor T22. In an embodiment, for example, the (4-2)th transistor T22 and the fourth additional transistor TADe4 may be connected between the data line DLj and a first node N21.

A gate electrode of the third additional transistor TADe3 and a gate electrode of the fourth additional transistor TADe4 may receive a same control signal. In an embodiment, for example, the gate electrode of the third additional transistor TADe3 and the gate electrode of the fourth additional transistor TADe4 may be connected to an (i+1)-th fourth scan line GD(i+1).

Conductivity types of the third additional transistor TADe3 and the fourth additional transistor TADe4 may be different from each other. In an embodiment, for example, the third additional transistor TADe3 may be an N-type transistor, and the fourth transistor TADe4 may be a P-type transistor. In an embodiment, conductivity types of the first additional transistor TADe1 and the fourth additional transistor TADe4 may be the same, and conductivity types of the second additional transistor TADe2 and the third additional transistor TADe3 may be the same.

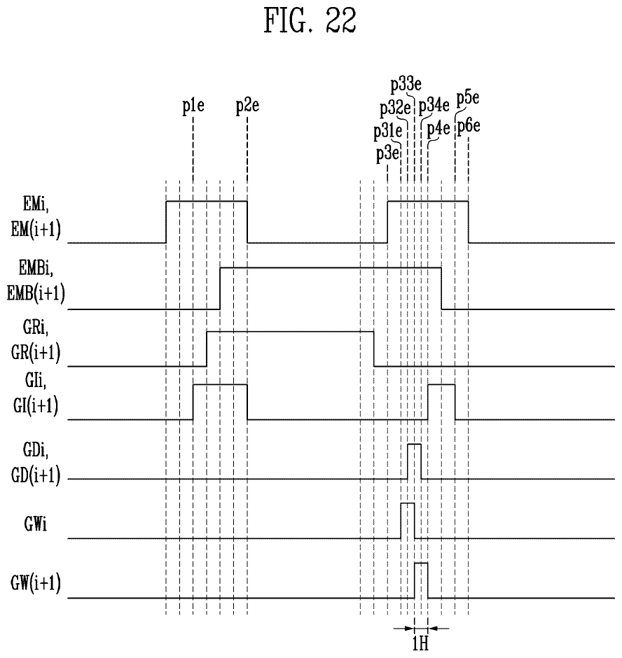

Referring to FIG. 22, an example signal timing diagram for driving the first to fourth pixels PXije1 to PX(i+1)je4 shown in FIG. 21 is illustrated. Time points p1e, p2e, p3e, p4e, p5e, and p6e shown in FIG. 22 correspond to the time points p21, p22, p23, p24, p25, p26 shown in FIG. 13, respectively, and therefore, any repetitive detailed descriptions thereof will be omitted. Signals shown in FIG. 22 are substantially the same as the signals shown in FIG. 13, except that a fourth signal is added and that the i-th fourth scan line GDi and the (i+1)-th forth scan line GD(i+1) receive a same fifth scan signal.

A control signal may be the fourth scan signal. The fourth scan driver 23GD which provides the control signal may be defined as a control scan driver. The fourth scan lines connected to the fourth scan driver 23GD may be defined as control lines. A number of scan stages included in the first scan driver 23GW may N. A number of scan stages included in each of the other scan drivers 23GI, 23GR, and 23GD except the first scan driver 23GW among the plurality of scan drivers may be M. Here, M may be an integer greater than 0, and N may be an integer greater than M. In an embodiment, for example, N may be double of M.

A voltage level of the control signal may be primarily changed during a period from a time point p31e to a time point p33e in which a (1-1)th scan signal having a turn-on level is received. In an embodiment, for example, a voltage level of the fourth scan signal may be changed at a time point p32e. During a period from the time point p31e to a time point p32e, the first pixel PXije1 may receive the first data voltage through the (1-2)th transistor T22 and the first additional transistor TADe1, which are turned on. During a period from the time point p32e to a time point p33e, the second pixel PXije2 may receive the second data voltage through the (2-2)th transistor T22 and the second additional transistor TADe2, which are turned on.

The period from the time point p31e to the time point p33e in which the (1-1)th scan signal having the turn-on level is received and a period from the time point p33e to a time point p4e in which a (1-2)th scan signal having a turn-on level is received may be different from each other. The (1-2)th scan signal applied to the (i+1)-th first scan line GW(i+1) may have a phase delayed by a horizontal period 1H from a phase of the (1-1)th scan signal applied to the i-th first scan line GWi.

The voltage level of the control signal may be secondarily changed during the period from the time point p33e to the time point p4e in which the (1-2)th scan signal having the turn-on level is received. In an embodiment, for example, the voltage level of the fourth scan signal may be changed at a time point p34e. During a period from the time point p33e to the time point p34e, the third pixel PX(i+1)je3 may receive the third data voltage through the (3-2)th transistor T22 and the third additional transistor TADe3, which are turned on. During a period from the time point p34e to the time point p4e, the fourth pixel PX(i+1)je4 may receive the fourth data voltage through the (4-2)th transistor T22 and the fourth additional transistor TADe4, which are turned on.

Thus, in accordance with an embodiment, although no demultiplexer exists between the data driver 22 and the pixel unit 24, the first to fourth pixels PXije1 to PX(i+1)je4 connected to the same data line DLj can time-divisionally receive the first to fourth data voltages, respectively.

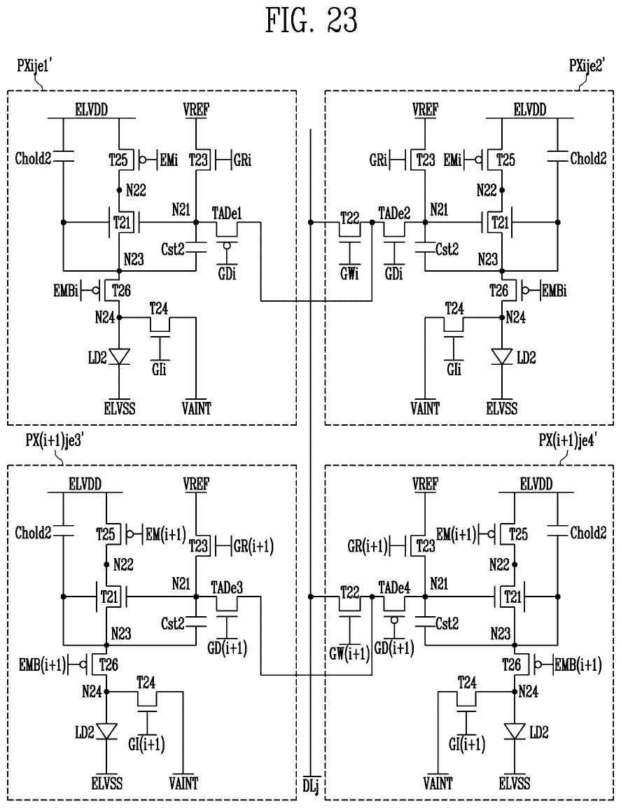

Referring to FIG. 23, a first pixel PXije1′ is substantially the same as the first pixel PXije1 shown in FIG. 21, except that the first pixel PXije1′ does not include the (1-2)th transistor T22. A first electrode of a first additional transistor TADe1 may be connected between a (2-2)th transistor T22 and a second additional transistor TADe2 of a second pixel PXije2′. In addition, a third pixel PX(i+1)je3′ is substantially the same as the third pixel PX(i+1)je3 shown in

FIG. 21, except that the third pixel PX(i+1)je3′ does not include the (3-2)th transistor T22. A first electrode of a third additional transistor TADe3 may be connected between a (4-2)th transistor T22 and a fourth additional transistor TADe4 of a fourth pixel PX(i+1)je4′. The first to fourth pixels PXije1′ to PX(i+1)je4′ shown in FIG. 23, may be driven with the signals of the timing diagram shown in FIG. 22.

In accordance with an embodiment, the first pixel PXije1′ does not include the (1-2)th transistor T22 and the third pixel PX(i+1)je3′ does not include the (3-2)th transistor T22, such that a space can be secured as compared with FIG. 21.

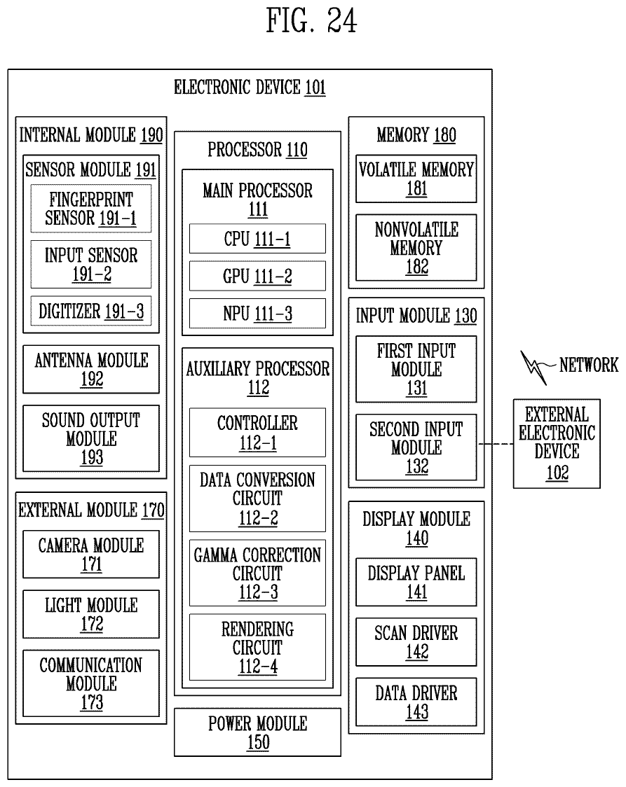

FIG. 24 is a block diagram of an electronic device 101 in accordance with embodiments of the disclosure.

An embodiment of the electronic device 101 may output various information through a display module 140. In case that a processor 110 executes an application stored in a memory 180, the display module 140 may provide application information to a user through a display panel 141.

The processor 110 may acquire an external input through an input module 130 or a sensor module 191, and execute an application corresponding to the external input. In an embodiment, for example, in case that the user selects a camera icon displayed on the display panel 141, the processor 110 may acquire a user input through an input sensor 191-2, and activate a camera module 171. The processor 110 may transfer, to the display module 140, image data corresponding to a photographed image acquired through the camera module 171. The display module 140 may display an image corresponding to the photographed image through the display panel 141.

In case that personal information authentication is executed in the display module 140, a fingerprint sensor 191-1 may acquire input fingerprint information as input data. The processor 110 may compare the input data acquired through the fingerprint sensor 191-1 with authentication data stored in the memory 180, and execute an application according to a comparison result. The display module 140 may display information executed according to a logic of the application through the display panel 141.

In case that a music streaming icon displayed on the display module 140 is selected, the processor 110 may acquire a user input through the input sensor 191-2, and active a music streaming application stored in the memory 180. In case that a music play command is input in the music streaming application, the processor 110 may activate a sound output module 193, thereby providing the user with sound information which accords with the music play command.

In the above, operations of the electronic device 101 have been briefly described. Hereinafter, components of the electronic device 101 will be described in detail. Some of the components of the electronic device 101, which will be described later, may be integrated to be provided as one component, and one component may be separated into two or more components to be provided.

Referring to FIG. 24, an embodiment of the electronic device 101 may communicate with an external electronic device 102 through a network (e.g., a short-range wireless communication network or a long-range wireless communication network). In accordance with an embodiment, the electronic device 101 may include the processor 110, the memory 180, the input module 130, the display module 140, a power module 150, an internal module 190, and an external module 170. In accordance with an embodiment, in the electronic device 101, at least one of the above-described components may be omitted, or one or more other components may be added. In accordance with an embodiment, some components (e.g., the sensor module 191, an antenna module 192, and/or the sound output module 193) among the above-described components may be integrated into another component (e.g., the display module 140).

The processor 110 may control at least another component (e.g., a hardware or software component) of the electronic device 101, which is connected to the processor 110, by executing software, and perform various processing or calculations. In accordance with an embodiment, as at least a portion of the data processing and calculations, the processor 110 may store, in a volatile memory 181, a command or data, received from another component (e.g., the input module 130, the sensor module 191, or a communication module 173), process the command or data, stored in the volatile memory 181, and store result data in a nonvolatile memory 182.

The processor 110 may include a main processor 111 and an auxiliary processor 112. The main processor 111 may include at least one selected from a central processing unit (CPU) 111-1 or an application processor (AP). The main processor 111 may further include at least one selected from a graphic processing unit (GPU) 111-2, a communication processor (CP), or an image signal processor (ISP). The main processor 111 may further include a neural processing unit (NPU) 111-3. The NPU 111-3 is a processor specified for processing an artificial intelligence (AI) model, and the AI model may be generated through machine learning. The AI model may include a plurality of artificial neural network layers. An artificial neural network may be a deep neural network (DNN), a convolutional neural network (CNN), a recurrent neural network (RNN), a restricted boltzman machine (RBM), a deep belief network (DBN), a bidirectional recurrent deep neural network (BRDNN), a deep Q-networks, or one of two or more combinations thereof, but the disclosure is not limited to the above-described example. The AI model may additionally or alternatively include a software structure, in addition to a hardware structure. At least two selected from the above-described processing units and the above-described processors may be implemented into one integrated component (e.g., a single chip), or be implemented as components (e.g., a plurality of chips) independent from each other.

In an embodiment, for example, the main processor 111 may provide the timing controller 11 shown in FIG. 1 with grayscales for an input image, control signals for an image, and the like.

The auxiliary processor 112 may include a controller 112-1. The controller 112-1 may include an interface conversion circuit and a timing control circuit. The controller 112-1 may receive an image signal from the main processor 111, and convert a data format of the image signal to be suitable for interface specifications with the display module 140, thereby outputting image data. The controller 112-1 may output various control signals necessary for driving of the display module 140. In an embodiment, for example, the auxiliary processor 112 may be the timing controller 11 shown in FIG. 1 or an integrated circuit including the timing controller 11.

The auxiliary processor 112 may further include a data conversion circuit 112-2, a gamma correction circuit 112-3, a rendering circuit 112-4, and the like. The data conversion circuit 112-2 may receive image data from the controller 112-1, and compensate for the image data such that an image is displayed with a desired luminance corresponding to a characteristic of the electronic device 101 or a setting of the user or convert the image data for the purpose of reduction of power consumption, afterimage compensation, or the like. The gamma correction circuit 112-3 may convert image data, a gamma reference voltage, or the like such that an image displayed in the electronic device 101 has a desired gamma characteristic. The rendering circuit 112-4 may receive image data from the controller 112-1, and render the image data by considering a pixel arrangement of the display panel 141, and the like, applied to the electronic device 101. At least one of the data conversion circuit 112-2, the gamma correction circuit 112-3, or the rendering circuit 112-4 may be integrated into another component (e.g., the main processor 111 or the controller 112-1). At least one selected from the data conversion circuit 112-2, the gamma correction circuit 112-3, or the rendering circuit 112-4 may be integrated into a data driver 143 which will be described later.

The memory 180 may store various data used by at least one component (e.g., the processor 110 or the sensor module 191) of the electronic device 101 and input or output data about a command associated therewith. The memory 180 may include at least one of the volatile memory 181 or the nonvolatile memory 182.

The input module 130 may receive a command or data to be used in a component (e.g., the processor 110, the sensor module 191, or the sound output module 193) of the electronic device 101 from the outside (e.g., the user or the external electronic device 102) of the electronic device 101.

The input module 130 may include a first input module 131 to which a command or data is input from the user and a second input module 132 to which a command or data is input from the external electronic device 102. The first input module 131 may include a microphone, a mouse, a keyboard, a key (e.g., a button), or a pen (e.g., a passive pen or an active pen). The second input module 132 may support a specified protocol capable of connecting the electronic device 101 to the external electronic device 102 by wired or wireless. In accordance with an embodiment, the second input module 132 may include a high definition multimedia interface (HDMI), a universal serial bus (USB) interface, an SD card interface, or an audio interface. The second input module 132 may include a connector, e.g., an HDMI connector, a USB connector, an SD card connector, or an audio connector (e.g., a headphone connector), which can physically connect the electronic device 101 to the external electronic device 102.

The display module 140 may visually provide information to the user. The display module 140 may include the display panel 141, a scan driver 142, and the data driver 143. The display module 140 may further include a window for protecting the display panel 141, a chassis, and a bracket.

The display panel 141 may include a liquid crystal display panel, an organic light emitting display panel, or an inorganic light emitting display panel, and the kind of the display panel 141 is not particularly limited. The display panel 141 may be of a rigid type or a flexible type in which the display panel 141 is rollable or foldable. The display module 140 may further include a supporter for supporting the display panel 141, a bracket, a heat dissipation member, or the like.

The scan driver 142 is a driving chip, and may be mounted in the display panel 141. Also, the scan driver 142 may be integrated in the display panel 141. In an embodiment, for example, the scan driver 142 may include an amorphous silicon TFT gate (ASG) driver circuit, a low temperature polycrystalline silicon (LTPS) TFT gate driver circuit, or an oxide semiconductor TFT gate (OSG) driver circuit, which is embedded in the display panel 141. The scan driver 142 may receive a control signal from the controller 112-1, and output scan signals to the display panel 141 in response to the control signal.

The display panel 141 may further include an emission driver. The emission driver may output an emission control signal to the display panel 141 in response to a control signal received from the controller 112-1. The emission driver may be formed separately from the scan driver 142, or be integrated in the scan driver 142.

The data driver 143 may receive a control signal from the controller 112-1, and convert image data into an analog voltage (e.g., a data voltage) and then output data voltages to the display panel 141 in response to the control signal.

The data driver 143 may be integrated in another component (e.g., the controller 112-1). Functions of the interface conversion circuit and the timing control circuit of the controller 112-1, which are described above, may be integrated in the data driver 143.

The display module 140 may further include an emission driver and a voltage generating circuit. The voltage generating circuit may output various voltages necessary for driving the display panel 141.

The power module 150 may supply power to at least one component of the electronic device 101. The power module 150 may include a battery for charging a power voltage. The battery may include a primary cell which is not rechargeable, a secondary cell which is rechargeable, or a fuel cell. The power module 150 may include a power management integrated circuit (PMIC). The PMIC may supply an optimized power source to each of the above-described modules and modules which will be described later. The power module 150 may include a wireless power transmission/reception member electrically connected to the battery. The wireless power transmission/reception member may include a plurality of coil-shaped antenna radiators.

The electronic device 101 may further include the internal module 190 and the external module 170. The internal module 190 may include the sensor module 191, the antenna module 192, and the sound output module 193. The external module 170 may include the camera module 171, a light module 172, and the communication module 173.

The sensor module 191 may sense an input caused by a body of the user or an input caused by a pen in the first input module 131, and generate an electrical signal or a data value, which corresponds to the input. The sensor module 191 may include at least one selected from the fingerprint sensor 191-1, the input sensor 191-2, or a digitizer 191-3.

The fingerprint sensor 191-1 may generate a data value corresponding to a fingerprint of the user. The fingerprint sensor 191-1 may include any one of an optical type fingerprint sensor and a capacitive type fingerprint sensor.

The input sensor 191-2 may generate a data value corresponding to coordinate information of the input caused by the body of the user or the input caused by the pen. The input sensor 191-2 may generate, as a data value, a capacitance variation caused by the input. The input sensor 191-2 may sense an input caused by a passive pen, or transmit/receive data to/from an active pen.

The input sensor 191-2 may measure a biometric signal such as pressure, moisture or body fat. In an embodiment, for example, in case that the user does not move for a constant time while a body part of the user is in contact with a sensor layer or a sensing panel, the input sensor 191-2 may output information which the user wants to the display module 140 by sensing a biometric signal, based on a change in electric field, caused by the body part.

The digitizer 191-3 may generate a data value corresponding to the coordinate information of the input caused by the pen. The digitizer 191-3 may generate, as a data value, an electromagnetic variation caused by the input. The digitizer 191-3 may sense an input caused by the passive pend, or transmit/receive data to/from the active pen.

At least one selected from the fingerprint sensor 191-1, the input sensor 191-2, or the digitizer 191-3 may be implemented as a sensor layer formed on the display panel 141 through a continuous process. At least one selected from the fingerprint sensor 191-1, the input sensor 191-2, or the digitizer 191-3 may be located at an upper side of the display panel 141, and any one, e.g., the digitizer 191-3 among the fingerprint sensor 191-1, the input sensor 191-2, and the digitizer 191-3 may be located at a lower side of the display panel 141.

At least two selected from the fingerprint sensor 191-1, the input sensor 191-2, and the digitizer 191-3 may be formed to be integrated into one sensing panel through the same process. In case that at least two selected from the fingerprint sensor 191-1, the input sensor 191-2, and the digitizer 191-3 are integrated into one sensing panel, the sensing panel may be located between the display panel 141 and the window located at an upper side of the display panel 141. In accordance with an embodiment, the sensing panel may be located on the window, and the position of the sensing panel is not particularly limited.

At least one selected from fingerprint sensor 191-1, the input sensor 191-2, or the digitizer 191-3 may be built in the display panel 141. That is, at least one selected from fingerprint sensor 191-1, the input sensor 191-2, or the digitizer 191-3 may be simultaneously formed through a process of forming elements (e.g., a light emitting element, a transistor, and the like) included in the display panel 141.

Besides, the sensor module 191 may generate an electrical signal or a data value, which corresponds to an internal state or an external state of the electronic device 101. The sensor module 191 may further include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The antenna module 192 may include one or more antennas for transmitting a signal or power to the outside or receiving a signal or power from the outside. In accordance with an embodiment, the communication module 173 may transmit a signal to the external electronic device or receive a signal from the external electronic device through an antenna suitable for a communication scheme. An antenna pattern of the antenna module 192 may be integrated in one component (e.g., the display panel 141) of the display module 140, the input sensor 191-2, or the like.

The sound output module 193 is a device for outputting a sound signal to the outside of the electronic device 101, and include, for example, a speaker used for a general purpose such as multimedia playback or transcription playback and a receiver used for only call reception. In accordance with an embodiment, the receiver may be integrally formed with the speaker or be formed separately from the speaker. A sound output pattern of the sound output module 193 may be integrated in the display module 140.

The camera module 171 may photograph a still image and moving images. In accordance with an embodiment, the camera module 171 may include one or more lenses, an image sensor, or an image signal processor. The camera module 171 may further include an infrared camera capable of measuring existence of the user, a position of the user, eyes of the user, or the like.

The light module 172 may provide light. The light module 172 may include a light emitting diode or a xenon lamp. The light module 172 may operate in linkage with the camera module 171 or operate independently from the camera module 171.

The communication module 173 may establish a wired or wireless communication channel between the electronic device 101 and the external electronic device 102, and support communication performance through the established communication channel. The communication module may include any one or all of a wireless communication module such as a cellular communication module, a short-range wireless communication module, or a global navigation satellite system (GNSS) communication module, and a wired communication module such as a local area network (LAN) communication module or a power line communication (PLC) module. The communication module 173 may communicate with the external electronic device 102 through a short-range communication network such as Bluetooth™, wireless-fidelity (WiFi) direct, or infrared data association (IrDA), or a long-range communication network such as a cellular network, Internet, or a computer network (e.g., LAN or wide area network (WAN)). The above-described several kinds of communication modules may be implemented into one chip or be respectively implemented as separate chips.

The input module 130, the sensor module 191, the camera module 171, and the like may be used to control an operation of the display module 140 in linkage with the processor 110.

The processor 110 may output a command or data to the display module 140, the sound output module 193, the camera module 171, or the light module 172, based on input data received from the input module 130. In an embodiment, for example, the processor 110 may generate image data, corresponding to input data applied through a mouse, an active pen, or the like, and output the image data to the display module 140. Alternatively, the processor 110 may generate command data, corresponding to the input data, and output the command data to the camera module 171 or the light module 172. In case that no input data is received from the input module 130, the processor 110 may change the operation mode of the electronic device 101 to a low power mode or a sleep mode, thereby reducing power consumed in the electronic device 101.

The processor 110 may output a command or data to the display module 140, the sound output module 193, the camera module 171, or the light module 172, based on sensing data received from the sensor module 191. In an embodiment, for example, the processor 110 may compare authentication data applied by the fingerprint sensor 191-1 with authentication data stored in the memory 180, and then execute an application according to a comparison result. The processor 110 may execute a command or output corresponding image data to the display module 140, based on sensing data sensed by the input sensor 191-2 or the digitizer 191-3. In case that a temperature sensor is included in the sensor module 191, the processor 110 may receive temperature data about a temperature measured from the sensor module 191, and further perform luminance correction on image data, based on the temperature data.

The processor 110 may receive measurement data about existence of the user, a position of the user, eyes of the user, or the like from the camera module 171. The processor 110 may further perform luminance correction on image data, based on the measurement data. In an embodiment, for example, the process 110 which decides the existence of the user through an input from the camera module 171 may output image data of which luminance is corrected to the display module 140 through the data conversion circuit 112-2 or the gamma correction circuit 112-3.

At least some of the above-described components may be connected to each other and communicate signals (e.g., commands or data) therebetween through an inter-peripheral communication scheme, e.g., a bus, a general purpose input/output (GPIO), a serial peripheral interface (SPI), a mobile industry processor interface (MIPI), or an ultra path interconnect (UPI) link. The processor 110 may communicate with the display module 140 through an appointed interface, and use any one of the above-described communication schemes. However, the disclosure is not limited to the above-described communication schemes.

The electronic device 101 in accordance with various embodiments disclosed in this document may be various types devices. The electronic device 101 may be, for example, a portable communication device (e.g., a smartphone), a computer device, a portable multimedia device, a portable medical device, a camera, a wearable device, or a home appliance. The electronic device 101 in accordance with an embodiment of the disclosure is not limited to the above-described devices.

In the display device and the electronic device in accordance with the embodiments of the disclosure, functions of a demultiplexer can be implemented in a pixel.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. A display device comprising:
a first pixel and a second pixel, connected to a same data line,
wherein the first pixel includes:
a (1-1)th transistor configured to control an amount of a first driving current, based on a first data voltage; and
a first additional transistor configured to receive the first data voltage from the data line,
wherein the second pixel includes:
a (2-1)th transistor configured to control an amount of a second driving current, based on a second data voltage;
a (2-2)th transistor configured to receive the second data voltage from the data line, wherein the (2-2) h transistor receives a (1-1)th scan signal; and
a second additional transistor configured to receive the second data voltage from the data line, wherein the second additional transistor is connected in series to the (2-2)th transistor, and
wherein a gate electrode of the first additional transistor and a gate electrode of the second additional transistor receive a same control signal, and
conductivity types of the first additional transistor and the second additional transistor are different from each other.

2. The display device of claim 1, wherein a voltage level of the same control signal is changed during a period in which the (1-1)th scan signal having a turn-on level is received.

3. The display device of claim 1, wherein the first pixel further includes a (1-2)th transistor configured to receive the first data voltage from the data line, wherein the (1-2)th transistor is connected in series to the first additional transistor.

4. The display device of claim 1, wherein a first electrode of the first additional transistor is connected between the (2-2)th transistor and the second additional transistor.

5. The display device of claim 1, further comprising:
a plurality of scan drivers,
wherein the plurality of scan drivers include a first scan driver configured to output the (1-1)th scan signal and a control scan driver configured to output the same control signal,
wherein a number of scan stages included in each of the first scan driver and the control scan driver is N,
wherein a number of scan stages included in each of the other scan drivers except the first scan driver and the control scan driver among the plurality of scan drivers is M, and
wherein M is an integer greater than 0, and N is an integer greater than M.

6. The display device of claim 1, further comprising:
a plurality of scan drivers,
wherein the plurality of scan drivers include a first scan driver configured to output the (1-1)th scan signal,
wherein a number of scan stages included in the first scan driver is N,
wherein a number of scan stages included in each of the other scan drivers except the first scan driver among the plurality of scan drivers is M, and
wherein M is an integer greater than 0, and N is an integer greater than M.

7. The display device of claim 6, further comprising:
a third pixel and a fourth pixel, connected to the data line,
wherein the third pixel includes:
a (3-1)th transistor configured to control an amount of a third driving current, based on a third data voltage; and
a third additional transistor configured to receive the third data voltage from the data line,
wherein the fourth pixel includes:
a (4-1)th transistor configured to control an amount of a fourth driving current, based on a fourth data voltage;
a (4-2)th transistor configured to receive the fourth data voltage from the data line, wherein the (4-2)th transistor receives a (1-2)th scan signal; and
a fourth additional transistor configured to receive the fourth data voltage from the data line, wherein the fourth additional transistor is connected in series to the (4-2)th transistor, and
wherein a gate electrode of the third additional transistor and a gate electrode of the fourth additional transistor receive the same control signal, and
conductivity types of the third additional transistor and the fourth additional transistor are different from each other.

8. The display device of claim 7, wherein conductivity types of the first additional transistor and the fourth additional transistor are the same as each other, and
wherein conductivity types of the second additional transistor and the third additional transistor are the same as each other.

9. The display device of claim 7, wherein a period in which the (1-1)th scan signal having a turn-on level is received and a period in which the (1-2)th scan signal having a turn-on level is received are different from each other,
wherein a voltage level of the same control signal is primarily changed during the period in which the (1-1)th scan signal having the turn-on level is received, and
wherein the voltage level of the same control signal is secondarily changed during the period in which the (1-2)th scan signal having the turn-on level is received.

10. The display device of claim 7, wherein the third pixel further includes a (3-2)th transistor configured to receive the third data voltage from the data line, wherein the (3-2)th transistor is connected in series to the third additional transistor.

11. The display device of claim 7, wherein a first electrode of the third additional transistor is connected between the (4-2)th transistor and the fourth additional transistor.

12. The display device of claim 1, wherein the first pixel further includes a (1-1)th emission transistor configured to allow the first driving current to flow therethrough in case that a (1-1)th emission signal having a turn-on level is received,
wherein the second pixel further includes a (2-1)th emission transistor configured to allow the second driving current to flow therethrough in case that the (1-1)th emission signal having the turn-on level is received,
wherein the same control signal is a (1-2)th emission signal, and
wherein the (1-1)th emission signal has a phase delayed from a phase of the (1-2)th emission signal.

13. The display device of claim 12, wherein the first pixel further includes a (1-2)th emission transistor configured to allow the first driving current to flow therethrough in case that a second emission signal having a turn-on level is received, and
wherein the second pixel further includes a (2-2)th emission transistor configured to allow the second driving current to flow therethrough in case that the second emission signal having the turn-on level is received.

14. The display device of claim 13, further comprising:
a first emission driver configured to output the (1-1)th emission signal and the (1-2)th emission signal; and
a second emission driver configured to output the second emission signal,
wherein a number of emission stages included in the first emission driver is P,
wherein a number of emission stages included in the second emission driver is Q, and
wherein Q is an integer greater than 0, and P is an integer greater than Q.

15. The display device of claim 13, wherein a gate electrode of the (2-1)th transistor is connected to a first node, a first electrode of the (2-1)th transistor is connected to a second node, and a second electrode of the (2-1)th transistor is connected to a third node,
wherein the (2-2)th transistor and the second additional transistor are connected between the data line and the first node,
wherein the (2-1)th emission transistor is connected between the third node and a fourth node, and
wherein the (2-2)th emission transistor is connected between the second node and a first power line.

16. The display device of claim 15, wherein the second pixel further includes:
a light emitting element including an anode electrode connected to the fourth node;
a (2-3)th transistor connected between the first node and a reference voltage line;
a (2-4)th transistor connected between the fourth node and an initialization voltage line;
a first capacitor connected between the first node and the third node; and
a second capacitor connected between the first power line and the third node.

17. The display device of claim 1, wherein a gate electrode of the (2-1)th transistor is connected to a first node, a first electrode of the (2-1)th transistor is connected to a second node, a second electrode of the (2-1)th transistor is connected to a third node, and a body of the (2-1)th transistor is connected to a fourth node, and
wherein the (2-2)th transistor and the second additional transistor are connected between the data line and the fourth node.

18. The display device of claim 17, wherein the second pixel further includes:
a light emitting element including an anode electrode connected to the third node;
a (2-3)th transistor connected between the fourth node and a reference voltage line; and
a (2-4)th transistor connected between the fourth node and an initialization voltage line.

19. The display device of claim 18, wherein the second pixel further includes:
a (2-5)th transistor connected between a first power line and the second node;
a (2-6)th transistor connected between the first power line and the first node; and
a (2-7)th transistor connected between the first node and the second node,
wherein a gate electrode of the (2-7)th transistor receives a (2-1)th scan signal,
wherein the same control signal is a (2-2)th scan signal, and
wherein the (2-2)th scan signal has a phase delayed from a phase of the (2-1)th scan signal.

20. An electronic device comprising:
a timing controller configured to receive grayscales for an input image from a processor;
a data driver configured to provide data voltages to data lines, based on the grayscales;
a scan driver configured to provide scan signals to scan lines;
a control scan driver configured to provide control signals to control lines; and
a display panel including a plurality of pixels connected to the data lines, the scan lines, and the control lines,
wherein the display panel includes a first pixel and a second pixel, connected to a same data line among the data lines,
wherein the first pixel includes:
a (1-1)th transistor configured to control an amount of a first driving current, based on a first data voltage; and
a first additional transistor configured to receive the first data voltage from the data line,
wherein the second pixel includes:
a (2-1)th transistor configured to control an amount of a second driving current, based on a second data voltage;
a (2-2)th transistor configured to receive the second data voltage from the data line, wherein the (2-2)th transistor receives a (1-1)th scan signal; and
a second additional transistor configured to receive the second data voltage from the data line, wherein the second additional transistor is connected in series to the (2-2)th transistor, and
wherein a gate electrode of the first additional transistor and a gate electrode of the second additional transistor receive a same control signal, and
conductivity types of the first additional transistor and the second additional transistor are different from each other.
